(19) United States
(12) Patent Application Publication
(10) Pub. No.: US 2025/0350026 A1
(43) Pub. Date: Nov. 13, 2025

(54) WIDEBEAM MULTIBAND ANTENNA

(71) Applicant: TE Connectivity Solutions GmbH, Schaffhausen (CH)

(72) Inventors: KokJiunn NG, Prai (MY); Rizwan KHAN, Prai (MY)

(21) Appl. No.: 19/199,570

(22) Filed: May 6, 2025

(30) Foreign Application Priority Data
May 8, 2024 (MY) PI2024002696

(51) Int. Cl. H01Q 5/378; H01Q 1/42; H01Q 9/16; H01Q 19/10

(52) U.S. Cl. CPC H01Q 5/378; H01Q 1/42; H01Q 9/16; H01Q 19/10

(57) ABSTRACT

An antenna includes a radome having walls at a top, bottom, front, rear, first side, and second side forming a chamber that receives an antenna assembly. The antenna assembly includes a multiband antenna element and a reflector spaced from the antenna element and facing the antenna element. The multiband antenna element includes a high band antenna with high band radiating arms and a low band antenna with low band radiating arms. The reflector includes a main reflector panel, front and rear reflector wings, main sidewalls on opposite sides of the main reflector panel, front and rear sidewalls on opposite sides of the front and rear reflector wings, and forward and rearward inner walls at the interfaces of the main reflector panel and the front and rear reflector wings.

### CROSS REFERENCE TO RELATED APPLICATIONS

This application claims the benefit of Malaysian Application No. PI2024002696, filed 8 May 2024, the subject matter of which is herein incorporated by reference in its entirety.

### BACKGROUND OF THE INVENTION

The subject matter herein relates generally to antennas.

Dual-band (2.4 GHz and 5 GHz) Wi-Fi Access Points (APs) and client devices are widely used in homes, businesses, and public spaces. While the client devices typically operate in either one of the two bands at any given time, the APs generally operate on both bands concurrently.

To add capacity and reduce congestion, some APs utilize “Tri-Band” solutions. Such APs operate in the same two bands but use two separate channels in the 5 GHz band in addition to the one in the 2.4 GHz band. So effectively there are three independent Wi-Fi networks (one in 2.4 GHz and two in 5 GHz) operating with a single AP. However, the 5 GHz band is limited in the amount of available bandwidth for the operation of two independent radios in maximum performance. Recently, Wi-Fi 6E and Wi-Fi 7 has been introduced, utilizing the frequency spectrum in the 6 GHz band for communication. With this newly available 6 GHz band, APs will Tri-Band communication and operate in 2.4 GHz, 5 GHZ, and 6 GHz concurrently.

The APs utilize multiband antennas with both directional and omnidirectional type. Typically, omnidirectional antenna is used for normal coverage but for better range and capacity, directional antenna can be used. For directional antenna design, the beamwidth of the antenna needs to be similar beamwidth across the triband. However, the antenna structures are typically complicated, expensive, and difficult to fabricate. Additionally, the antenna structures typically have a large overall size to achieve the wide beamwidth and high back to front ratio. Conventional wide beam multiband antennas have poor performance in term of consistent beamwidth across multi or wide band range.

A need remains for a wide beam multiband antenna having improved performance with consistent beamwidth, gain and front to back ratio.

### BRIEF DESCRIPTION OF THE INVENTION

In one embodiment, an antenna is provided and includes a radome that has walls forming a chamber. The radome has a top, a bottom, a front, a rear, a first side, and a second side. The antenna includes an antenna assembly received in the chamber. The antenna assembly includes a multiband antenna element and a reflector spaced from the antenna element and facing the antenna element. The multiband antenna element includes a high band antenna includes high band radiating arms. The multiband antenna element includes a low band antenna includes low band radiating arms. The reflector includes a main reflector panel, a front reflector wing forward of the main reflector panel, a rear reflector wing rearward of the main reflector panel, main sidewalls on opposite sides of the main reflector panel, front sidewalls on opposite sides of the front reflector wing, rear sidewalls on opposite sides of the rear reflector wing, a forward inner wall at the interface of the main reflector panel and the front reflector wing, and a rearward inner wall at the interface of the main reflector panel and the rear reflector wing.

In another embodiment, an antenna assembly is provided and includes a multiband antenna element that includes a high band antenna includes high band radiating arms and a low band antenna includes low band radiating arms. The antenna assembly includes a reflector spaced from the multiband antenna element and facing the antenna element. The reflector includes a main reflector panel, a front reflector wing forward of the main reflector panel, a rear reflector wing rearward of the main reflector panel, main sidewalls on opposite sides of the main reflector panel, front sidewalls on opposite sides of the front reflector wing, rear sidewalls on opposite sides of the rear reflector wing, a forward inner wall at the interface of the main reflector panel and the front reflector wing, and a rearward inner wall at the interface of the main reflector panel and the rear reflector wing.

In a further embodiment, an antenna assembly is provided and includes a multiband antenna element that includes a high band antenna includes high band radiating arms and a low band antenna includes low band radiating arms. The antenna assembly includes a reflector spaced from the multiband antenna element and facing the antenna element. The reflector includes a main reflector panel, a front reflector wing forward of the main reflector panel, a rear reflector wing rearward of the main reflector panel, main sidewalls on opposite sides of the main reflector panel, front sidewalls on opposite sides of the front reflector wing, rear sidewalls on opposite sides of the rear reflector wing, a forward inner wall at the interface of the main reflector panel and the front reflector wing, and a rearward inner wall at the interface of the main reflector panel and the rear reflector wing. The antenna assembly includes a secondary reflector spaced from the multiband antenna element. The secondary reflector includes a central panel aligned with the high band radiating arms and the low band radiating arms.

### BRIEF DESCRIPTION OF THE DRAWINGS

FIG. 1 is a side view of an antenna in accordance with an exemplary embodiment.

FIG. 2 is an end view of the antenna in accordance with an exemplary embodiment.

FIG. 3 is a rear perspective view of the antenna in accordance with an exemplary embodiment.

FIG. 4 illustrates the antenna in accordance with an exemplary embodiment.

FIG. 5 illustrates the antenna in accordance with an exemplary embodiment.

FIG. 6 is a perspective view of the antenna assembly in accordance with an exemplary embodiment.

FIG. 7 is a side view of the antenna assembly in accordance with an exemplary embodiment.

FIG. 8 is a top view of the antenna assembly in accordance with an exemplary embodiment.

FIG. 9 is a perspective view of the reflector in accordance with an exemplary embodiment.

FIG. 10 is a chart showing performance summary of the antenna shown in FIGS. 6-8 using the reflector shown in FIG. 9 in accordance with an exemplary embodiment.

FIG. 11 shows the antenna radiation pattern in the Azimuth plane at the low band for the antenna shown in FIGS. 6-8 using the reflector shown in FIG. 9 in accordance with an exemplary embodiment.

FIG. 12 shows the antenna radiation pattern in the Elevation plane at the low band for the antenna shown in FIGS. 6-8 using the reflector shown in FIG. 9 in accordance with an exemplary embodiment.

FIG. 13 shows the antenna radiation pattern in the Azimuth plane at the high band for the antenna shown in FIGS. 6-8 using the reflector shown in FIG. 9 in accordance with an exemplary embodiment.

FIG. 14 shows the antenna radiation pattern in the Elevation plane at the high band for the antenna shown in FIGS. 6-8 using the reflector shown in FIG. 9 in accordance with an exemplary embodiment.

FIG. 15 is a perspective view of the antenna assembly in accordance with an exemplary embodiment.

FIG. 16 is a side view of the antenna assembly in accordance with an exemplary embodiment.

FIG. 17 is a top view of the antenna assembly in accordance with an exemplary embodiment.

FIG. 18 is a perspective view of the reflector and the secondary reflector in accordance with an exemplary embodiment.

FIG. 19 is a perspective view of the secondary reflector in accordance with an exemplary embodiment with the reflector removed to illustrate the parts of the secondary reflector.

FIG. 20 is a chart showing performance summary of the antenna shown in FIGS. 15-17 using the reflector shown in FIG. 18 and the secondary reflector shown in FIG. 19 in accordance with an exemplary embodiment.

FIG. 21 shows the antenna radiation pattern in the Azimuth plane at the low band for the antenna shown in FIGS. 15-17 using the reflector shown in FIG. 18 and the secondary reflector shown in FIG. 19 in accordance with an exemplary embodiment.

FIG. 22 shows the antenna radiation pattern in the Elevation plane at the low band for the antenna shown in FIGS. 15-17 using the reflector shown in FIG. 18 and the secondary reflector shown in FIG. 19 in accordance with an exemplary embodiment.

FIG. 23 shows the antenna radiation pattern in the Azimuth plane at the high band for the antenna shown in FIGS. 15-17 using the reflector shown in FIG. 18 and the secondary reflector shown in FIG. 19 in accordance with an exemplary embodiment.

FIG. 24 shows the antenna radiation pattern in the Elevation plane at the high band for the antenna shown in FIGS. 15-17 using the reflector shown in FIG. 18 and the secondary reflector shown in FIG. 19 in accordance with an exemplary embodiment.

### DETAILED DESCRIPTION OF THE INVENTION

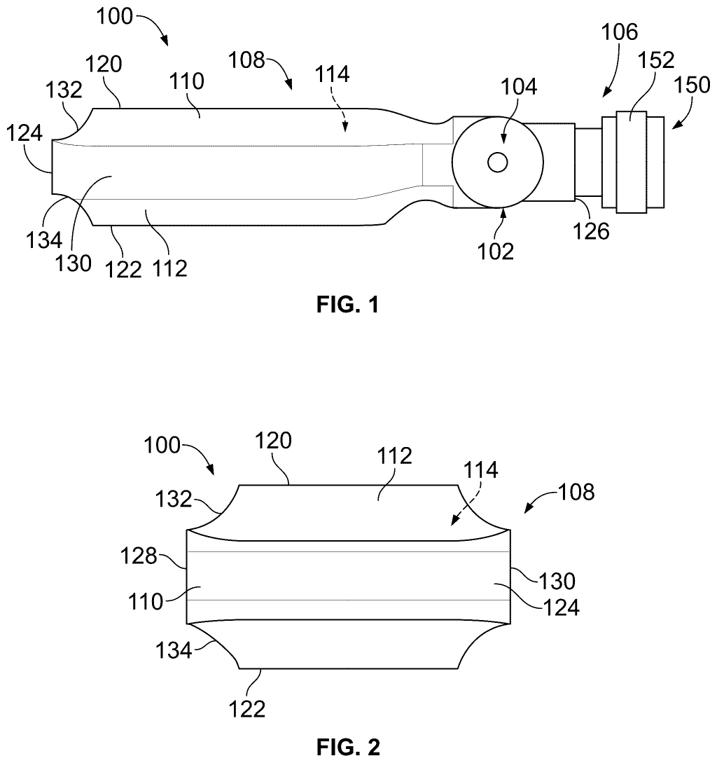

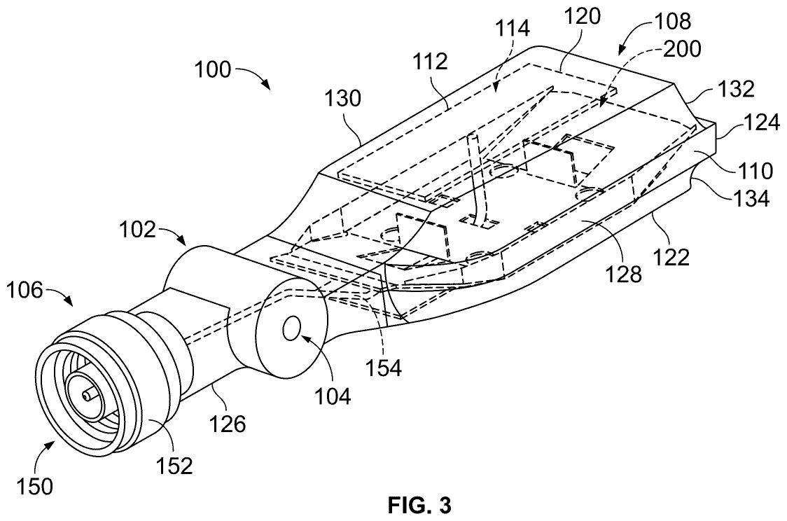

FIG. 1 is a side view of an antenna 100 in accordance with an exemplary embodiment. FIG. 2 is an end view of the antenna 100 in accordance with an exemplary embodiment. FIG. 3 is a rear perspective view of the antenna 100 in accordance with an exemplary embodiment.

In an exemplary embodiment, the antenna 100 is used for a Wi-Fi access point (AP), but may not be limited to Wi-Fi applications. In the illustrated embodiment, the antenna 100 is an articulating panel antenna having an articulating portion 102 configured to allow adjustment in positioning of the antenna 100. For example, the articulating portion 102 includes a rotating hinge 104 between a mounting portion 106 and a main portion 108 of the antenna 100. Other types of articulating portions may be provided in alternative embodiments. In other various embodiments, the antenna 100 may be a fixed panel antenna or a stud mount panel antenna with a pigtail cable connection extending therefrom. The antenna 100 may be used in other types of applications in alternative embodiments other than as a Wi-Fi access point.

In an exemplary embodiment, the antenna 100 is a multiband antenna operable in more than one frequency range. For example, the antenna 100 may be operable in multiple different Wi-Fi frequency bands, such as one or more low band frequency ranges and/or one or more high band frequency ranges. In an exemplary embodiment, the antenna 100 is operable at a frequency range of between 2.4 and 2.5 GHz and the antenna 100 is operable at a frequency range of between 5.15 and 7.125 GHz to cover the 2.4 GHz Wi-Fi band, the 5 GHz Wi-Fi band, and the 6 GHz Wi-Fi band. In an exemplary embodiment, the antenna 100 can be used for multiple-input and multiple-output (MIMO) communication when having multiple antennas on the AP or device. In an exemplary embodiment, the antenna 100 may have wide high band and/or wide low band antenna pattern control. The antenna 100 may have a wide beam width at the azimuth plane. The antenna 100 may have a moderate beam width at the elevation plane. In an exemplary embodiment, the antenna 100 has an azimuth beam with approximately 90° or greater and an elevation beam with of approximately 60°. The antenna 100 can be configured for various setting of beam width. The antenna 100 has a gain above 6.0 dBi with a front-to-back ratio of better than 12 dB. In an exemplary embodiment, the antenna 100 may have a limited size, such as to fit within a particular confined space or shaped antenna device. In an exemplary embodiment, the antenna 100 is a tri-band dipole antenna that offers a good radiation pattern while maintaining a good front-to-back ratio across the tri-band frequency range. In an exemplary embodiment, the antenna 100 includes a reflector for antenna pattern control, such as to provide wide azimuth beam width, to control antenna gain, and to improve the front-to-back ratio of the antenna. In an exemplary embodiment, the reflector of the antenna 100 is sized/shaped/spaced to the dipole antenna to harmonize the radiation pattern between the low band and the high band of the antenna 100. In an exemplary embodiment, the radiating elements of the antenna and the reflector are designed to provide a generally symmetrical radiation pattern. In an exemplary embodiment, the antenna 100 may include matching elements to control the antenna characteristics, such as a balun coupling radiating element and/or lump components and/or in EEPROM.

In an exemplary embodiment, the antenna 100 includes a radome 110, an antenna assembly 200 (shown in phantom in FIG. 3) in the radome 110, and an antenna feed 150 coupled to the antenna assembly 200. In various embodiments, the antenna feed 150 is coupled to the radome 110. For example, the antenna feed 150 includes an RF connector 152 coupled to the end of the radome 110 and a coaxial cable 154 extending from the RF connector 152 to the antenna assembly 200. The radome 110 has a size and shape that defines a confined space for the antenna assembly 200. The antenna assembly 200 is sized and shaped to fit within the confined space of the radome 110. The radome 110 is a cover or casing surrounding and protecting the antenna assembly 200 as well as holding and locating the radiating elements and reflectors.

The radome 110 includes walls 112 forming a chamber 114. The antenna assembly 200 is received in the chamber 114. In the illustrated embodiment, the radome 110 includes the articulating portion 102 between the mounting portion 106 and the main portion 108. The antenna assembly 200 is received in the main portion 108. The antenna feed 150 is coupled to the mounting portion 106. The antenna feed 150 extends through the articulating portion 102 to electrically connect to the antenna assembly 200 in the main portion 108. In an exemplary embodiment, the radome 110 includes a top 120, a bottom 122, a front 124, a rear 126, a first side 128, and a second side 130. The walls 112 may be flat at the top 120 and/or the bottom 122 and/or the front 124 and/or the rear 126 and/or the first side 128 and/or the second side 130. The walls 112 may be curved at the top 120 and/or the bottom 122 and/or the front 124 and/or the rear 126 and/or the first side 128 and/or the second side 130. The walls 112 may be curved at the intersections or corners. The radome 110 may have other shapes in alternative embodiments. In an exemplary embodiment, the radome 110 is generally long and narrow. For example, the radome 110 is long between the front 124 in the rear 126 and is narrow between the first and second sides 128, 130. In an exemplary embodiment, the radome 110 has a low profile thickness between the top 120 and the bottom 122. For example, the thickness is the shortest dimension of the radome 110, whereas the length is the longest dimension of the radome 110.

In an exemplary embodiment, the radome 110 is manufactured from a plastic material. For example, the radome 110 may be a molded part. In an exemplary embodiment, the radome 110 may be a multi-piece structure, such as including an upper casing 132 and a lower casing 134.

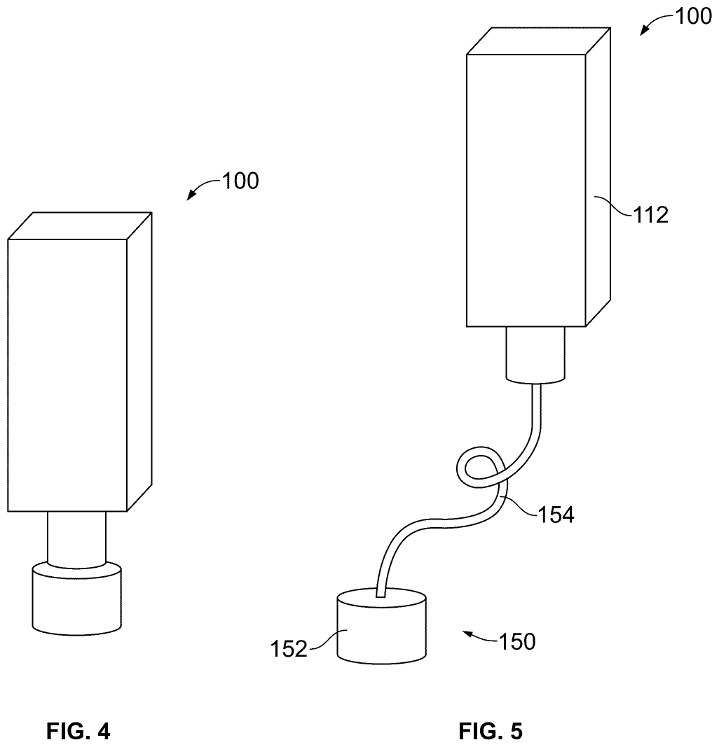

FIG. 4 illustrates the antenna 100 in accordance with an exemplary embodiment. In the illustrated embodiment, the antenna 100 is a fixed panel access point rather than the articulating panel access point illustrated in FIGS. 1-3. The antenna 100 may have other shapes or sizes in alternative embodiments.

FIG. 5 illustrates the antenna 100 in accordance with an exemplary embodiment. In the illustrated embodiment, the antenna 100 is a stud mount panel antenna with a pigtail cable connection extending therefrom. For example, the RF connector 152 of the antenna feed 150 is located remote from the radome 110 and connected to the radome 110 and the antenna assembly 200 by the coaxial cable 154 extending from the end of the radome 110. The antenna 100 may have other shapes or sizes in alternative embodiments.

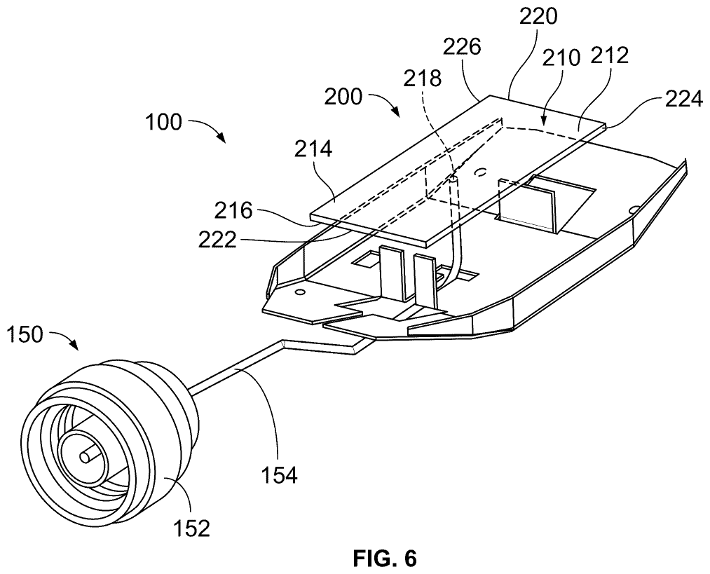

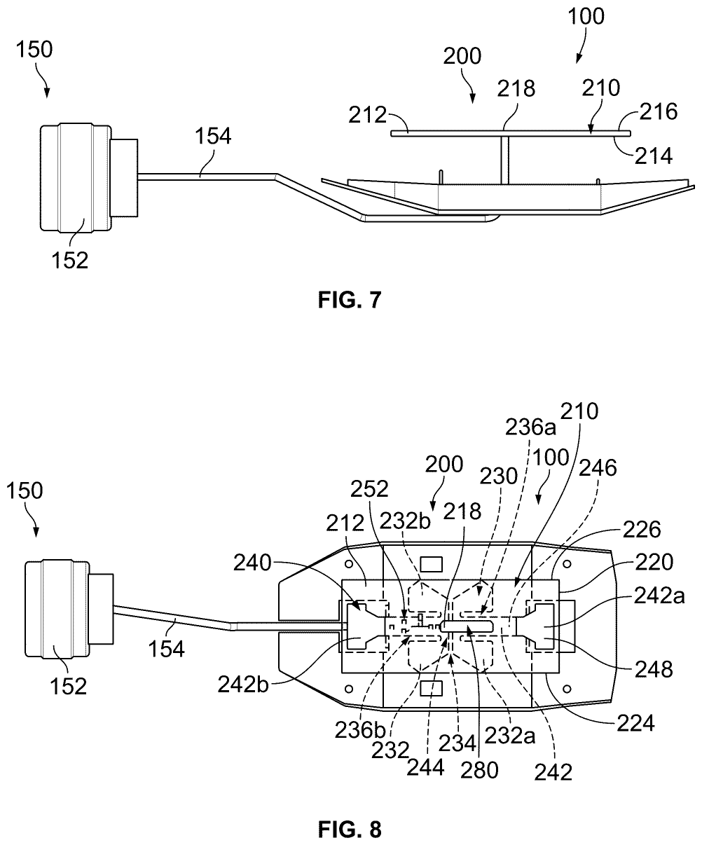

FIG. 6 is a perspective view of the antenna assembly 200 in accordance with an exemplary embodiment. FIG. 7 is a side view of the antenna assembly 200 in accordance with an exemplary embodiment. FIG. 8 is a top view of the antenna assembly 200 in accordance with an exemplary embodiment. FIGS. 6-8 illustrate the antenna feed 150 coupled to the antenna assembly 200. For example, the RF connector 152 of the antenna feed 150 is coupled to the antenna assembly 200 by the coaxial cable 154.

The antenna assembly 200 includes a multiband antenna element 210 and a reflector 300 spaced from the antenna element 210 and facing the antenna element 210. In an exemplary embodiment, the reflector 300 is a stamped and formed part. For example, the reflector 300 may be stamped from a metal sheet and formed into a particular shape designed to control and improve radiation pattern performance of the multiband antenna element 210. In an exemplary embodiment, the reflector 300 provides antenna pattern control, such as to provide azimuth wide beam width, to control antenna gain, and to improve the front-to-back ratio of the antenna element 210. In an exemplary embodiment, the reflector 300 is sized/shaped/spaced to the antenna element 210 to harmonize the radiation pattern, such as between a low band and a high band of the antenna element 210. In an exemplary embodiment, the reflector 300 is designed to provide a generally symmetrical radiation pattern for the antenna element 210.

In an exemplary embodiment, the antenna element 210 is a multiband antenna element 210 operable in more than one frequency range. For example, the antenna 100 may be operable in multiple different Wi-Fi frequency bands, such as one or more low band frequency ranges and/or one or more high band frequency ranges. In an exemplary embodiment, the antenna element 210 is a triband antenna element operable at frequency ranges of between 2.4 and 2.5 GHz and between 5.15 and 7.125 GHz to cover the 2.4 GHz Wi-Fi band, the 5 GHz Wi-Fi band, and the 6 GHz Wi-Fi band. The antenna element 210 may be designed to be operable in additional or different frequency ranges in alternative embodiments.

In an exemplary embodiment, the antenna element 210 includes a high band antenna 230 and a low band antenna 240. The high band antenna 230 is operable at higher frequency ranges than the low band antenna 240. The low band antenna 240 is operable at lower frequency ranges than the high band antenna 230. In an exemplary embodiment, the low band antenna 240 is operable at frequency ranges of between 2.4 and 2.5 GHz and the high band antenna 230 is operable at frequency ranges of between 5.15 and 7.125 GHz.

In an exemplary embodiment, the antenna element 210 includes an antenna printed circuit board 212. The high band antenna 230 and the low band antenna 240 are defined by circuits of the antenna printed circuit board 212. The circuits may be provided on one or more layers of the antenna printed circuit board 212. The antenna printed circuit board 212 includes a lower surface 214 and an upper surface 216. The high band antenna 230 may be provided on the lower surface 214 and/or the upper surface 216. The low band antenna 240 may be provided on the lower surface 214 and/or the upper surface 216. In an exemplary embodiment, the antenna element 210 includes a feed 218 for the high band antenna 230 and/or the low band antenna 240. In the illustrated embodiment, the antenna element 210 includes a single feed. In alternative embodiments, the antenna element 210 may include multiple feeds. The coaxial cable 154 of the antenna feed 150 is coupled to the feed 218 of the antenna element 210. The feed 218 may be defined by a via or pad of the antenna printed circuit board 212. The center conductor of the coaxial cable 154 may be soldered to the feed 218. The coaxial cable 154 may extend generally perpendicular to the antenna printed circuit board 212, such as downward from the lower surface 214.

In an exemplary embodiment, the antenna printed circuit board 212 extends between a front 220 and a rear 222. The antenna printed circuit board 212 as a first side 224 and a second side 226. The antenna printed circuit board 212 has a length between the front 220 in the rear 222 and has a width between the first and second sides 224, 226. In an exemplary embodiment, the antenna printed circuit board 212 is generally long and narrow to correspond to the shape of the radome 110. Other shapes are possible in alternative embodiments.

In alternative embodiments, the antenna element 210 may be provided without the antenna printed circuit board 212. Rather, the antenna element 210 may include stamped metal elements or other types of conductive elements defining radiating elements of the antenna element 210.

The high band antenna 230 includes high band radiating arms 232. In an exemplary embodiment, the high band radiating arms 232 are formed by circuits of the antenna printed circuit board 212. In the illustrated embodiment, the high band radiating arms 232 are shown in phantom in FIG. 8 and are provided on the lower surface 214 of the antenna printed circuit board 212. In an exemplary embodiment, the high band antenna 230 is a dipole antenna having one or more first high band radiating arms 232a and one or more second high band radiating arms 232b on opposite sides of the feed 218. The first and second high band radiating arms 232a, 232b may be separated by a slot 234. In various embodiments, multiple first high band radiating arms 232a are provided, such as on opposite sides of a gap 236a. Optionally, the low band antenna 240 may pass through the gap 236a between the first high band radiating arms 232a. The first high band radiating arms 232a may be rectangular, triangular, wedge shaped, trapezoidal, bowtie shaped, or have other shapes. In various embodiments, multiple second high band radiating arms 232b are provided, such as on opposite sides of a gap 236b. Optionally, the low band antenna 240 may pass through the gap 236b between the second high band radiating arms 232b. The second high band radiating arms 232b may be rectangular, triangular, wedge shaped, trapezoidal, bowtie shaped, or have other shapes. In an exemplary embodiment, the high band antenna 230 includes four high band radiating arms 232 generally arranged in quadrants crossing the feed 218. For example, the high band radiating arms 232 may form a cross dipole pattern. The high band radiating arms 232 may be generally X-shaped. The high band antenna 230 may have other shapes in alternative embodiments.

The low band antenna 240 includes low band radiating arms 242. In an exemplary embodiment, the low band radiating arms 242 are formed by circuits of the antenna printed circuit board 212. In the illustrated embodiment, the low band radiating arms 242 are shown partially in phantom in FIG. 8. In an exemplary embodiment, portions of the low band radiating arms 242 are provided on the lower surface 214 of the antenna printed circuit board 212 and portions of the low band radiating arms 242 are provided on the upper surface 216. In an exemplary embodiment, the low band antenna 240 is a dipole antenna having one or more first low band radiating arms 242a and one or more second low band radiating arms 242b on opposite sides of the feed 218. The first and second low band radiating arms 242a, 242b may be separated by a slot 244. In the illustrated embodiment, each low band radiating arm 242 includes a post 246 and a pad 248 at the distal end of the post 246. The post 246 extends between the feed 218 and the pad 248. The post 246 is generally long and narrow. The post 246 may be generally rectangular; however, the post 246 may have other shapes in alternative embodiments. The pad 248 is wider than the post 246. The pad 248 may be rectangular, triangular, wedge shaped, funnel shaped, trapezoidal, or have other shapes. In the illustrated embodiment, the post 246 is provided on the lower surface 214 and the pad 248 is provided on the upper surface 216. The post 246 may be connected to the pad 248 by one or more vias through the antenna printed circuit board 212. In an exemplary embodiment, the low band antenna 240 includes two low band radiating arms 242 arranged on opposite front and rear sides of the feed 218. The low band antenna 240 may have other shapes in alternative embodiments.

In an exemplary embodiment, the antenna element 210 includes a balun coupling radiating element 250. The balun coupling radiating element 250 controls balance between the high band radiating arms 232 and controls balance between the low band radiating arms 242. The balun coupling radiating element 250 may be defined by one or more circuits of the antenna printed circuit board 212. The balun coupling radiating element 250 may be provided on the upper surface 216. The balun coupling radiating element 250 may be coupled to the feed 218. In other various embodiments, the balun coupling radiating element 250 may be a separate electrical component coupled to the antenna printed circuit board 212, such as being mounted to the upper surface 216 of the antenna printed circuit board 212.

In an exemplary embodiment, the antenna element 210 includes one or more lump components 252 to increase the bandwidth of the antenna element 210. The lump components 252 may include a lumped resistor, capacitor, and/or inductor to change the electrical properties of the antenna element 210. The lump components 252 may be mounted to the antenna printed circuit board 212, such as to the upper surface 216. The lump components 252 may be electrically connected to the feed 218. The component 252 may include an inductor filter as low pass filter and an EEPROM to store information of the antenna.

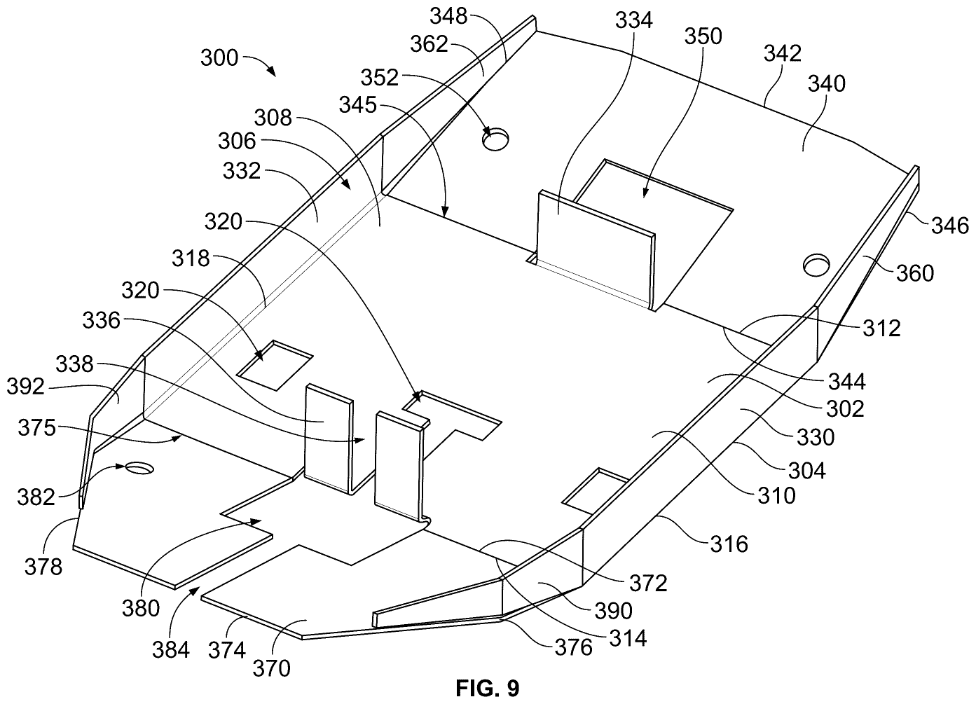

FIG. 9 is a perspective view of the reflector 300 in accordance with an exemplary embodiment. The reflector 300 is a stamped and formed part. For example, the reflector 300 may be stamped from a metal sheet and formed into a particular shape designed to control and improve performance of the multiband antenna assembly 200.

The reflector 300 includes panels 302 that form the shape of the reflector 300. The panels 302 meet at edges 304. For example, the panels 302 are bent or angled relative to each other at corners along the edges 304 of the panels 302. The reflector 300 may have a concave shape. For example, the panels 302 may form a concavity 306 that faces the antenna assembly 200. Each panel 302 has an inner surface 308 that faces the concavity 306.

In an exemplary embodiment, the reflector 300 includes a main reflector panel 310, a front reflector wing 340 forward of the main reflector panel 310, and a rear reflector wing 370 rearward of the main reflector panel 310. In an exemplary embodiment, the reflector 300 includes main sidewalls 330, 332 on opposite sides of the main reflector panel 310. In an exemplary embodiment, the reflector 300 includes front sidewalls 360, 362 on opposite sides of the front reflector wing 340 and rear sidewalls 390 392 on opposite sides of the rear reflector wing 370. In an exemplary embodiment, the reflector includes a forward inner wall 334 at the interface of the main reflector panel 310 and the front reflector wing 340 and a rearward inner wall 336 at the interface of the main reflector panel 310 and the rear reflector wing 370. The reflector 300 may include additional panels 302 in other various embodiments changing the shape of the reflector 300.

In an exemplary embodiment, the main reflector panel 310 is planar. However, the main reflector panel 310 may be curved, such as front to rear and/or side to side. In the illustrated embodiment, the main reflector panel 310 is generally rectangular. However, the main reflector panel 310 may have other shapes in alternative embodiments. The main reflector panel 310 includes a front 312 and a rear 314. The main reflector panel 310 extends between a first side 316 and a second side 318. In an exemplary embodiment, the first and second sides 316, 318 are parallel to each other. Optionally, the first and second sides 316, 318 may be perpendicular to the front 312 and/or the rear 314. The main reflector panel 310 has a width between the first and second sides 316, 318. The main reflector panel 310 has a length between the front 312 and the rear 314. The width and the length may be selected based on the width and the length of the radome 110, such as the main portion 108 of the radome 110. The width and the length may be selected based on the width and the length of the antenna element 210. For example, the width and/or the length may be selected based on the positioning of the high band antenna 230 and/or the positioning of the low band antenna 240. In an exemplary embodiment, the width of the main reflector panel 310 is wider than the width of the high band antenna 230 and the low band antenna 240. In an exemplary embodiment, the length of the main reflector panel 310 is longer than the length of the high band antenna 230. The length of the main reflector panel 310 may be shorter than the length of the low band antenna 240.

In an exemplary embodiment, the main reflector panel 310 includes slots 320 formed in the main reflector panel 310. The slots 320 may allow components to pass through the main reflector panel 310. For example, one of the slots 320 may receive the coaxial cable 154 (FIG. 6). The slots 320 may receive portions of the radome 110, such as support walls used to support the reflector 300 and/or the antenna element 210. The slots 320 may be used to control the reflective characteristics of the reflector 300, such as to control the antenna pattern.

The main sidewalls 330, 332 extend from the first and second sides 316, 318, respectively. In an exemplary embodiment, the main sidewalls 330, 332 are perpendicular to the main reflector panel 310. For example, the main reflector panel 310 may be oriented horizontally and the main sidewalls 330, 332 may be oriented vertically. Other orientations are possible in alternative embodiments. The main sidewalls 330, 332 provide antenna pattern control of the azimuth plane beamwidth. The main sidewalls 330, 332 have a height measured between the main reflector panel 310 and the outer edge of the main sidewalls 330, 332. In an exemplary embodiment, the height of the first side wall 330 is the same as the height of the second side wall 332. However, in alternative embodiments, the heights of the main sidewalls 330, 332 may be different than each other. Optionally, the main sidewalls 330, 332 may have a variable height, such as having portions that are taller and portions that are shorter. In various embodiments, the main sidewalls 330, 332 may include one or more slots (not shown), which may be open at the bottom and/or the top and/or the sides.

The forward inner wall 334 is located at or near the interface of the main reflector panel 310 and the front reflector wing 340. The forward inner wall 334 extends from the main reflector panel 310. In an exemplary embodiment, the forward inner wall 334 is oriented generally perpendicular to the main reflector panel 310. For example, the main reflector panel 310 may be oriented horizontally and the forward inner wall 334 may be oriented generally vertically. The forward inner wall 334 may be aligned with the high band antenna 230 to control the antenna pattern of the high band antenna 230. For example, the forward inner wall 334 may widen or increase the elevation beamwidth for the high band antenna 230. In an exemplary embodiment, the forward inner wall 334 is stamped from the front reflector wing 340 and bent at an angle relative to the main reflector panel 310, such as a right angle. In an exemplary embodiment, the forward inner wall 334 is generally rectangular shaped. However, the forward inner wall 334 may have other shapes in alternative embodiments. The forward inner wall 334 has a height measured between the main reflector panel 310 and the outer edge of the forward inner wall 334. The height of the forward inner wall 334 may be similar to the height of the main sidewalls 330, 332. In alternative embodiments, the height of the forward inner wall 334 may be different than the height of the main sidewalls 330, 332, such as being taller than the main sidewalls 330, 332. Optionally, the forward inner wall 334 may have a variable height, such as having portions that are taller and portions that are shorter. In various embodiments, the forward inner wall 334 may include one or more slots (not shown) in the forward inner wall 334, which may be open at the bottom and/or the top and/or the sides.

The rearward inner wall 336 is located at or near the interface of the main reflector panel 310 and the rear reflector wing 370. The rearward inner wall 336 extends from the main reflector panel 310. In an exemplary embodiment, the rearward inner wall 336 is oriented generally perpendicular to the main reflector panel 310. For example, the main reflector panel 310 may be oriented horizontally and the rearward inner wall 336 may be oriented generally vertically. The rearward inner wall 336 may be aligned with the high band antenna 230 to control the antenna pattern of the high band antenna 230. For example, the rearward inner wall 336 may widen or increase the elevation beamwidth for the high band antenna 230. In an exemplary embodiment, the rearward inner wall 336 is stamped from the rear reflector wing 370 and bent at an angle relative to the main reflector panel 310, such as a right angle. In an exemplary embodiment, the rearward inner wall 336 is generally rectangular shaped. However, the rearward inner wall 336 may have other shapes in alternative embodiments. The rearward inner wall 336 has a height measured between the main reflector panel 310 and the outer edge of the rearward inner wall 336. The height of the rearward inner wall 336 may be similar to the height of the main sidewalls 330, 332. In alternative embodiments, the height of the rearward inner wall 336 may be different than the height of the main sidewalls 330, 332, such as being taller than the main sidewalls 330, 332. Optionally, the rearward inner wall 336 may have a variable height, such as having portions that are taller and portions that are shorter. In various embodiments, the rearward inner wall 336 may include one or more slots 338 in the rearward inner wall 336, which may be open at the bottom and/or the top and/or the sides. The slot 338 may receive the coaxial cable 154 during assembly to allow the coaxial cable 154 to pass through the reflector 300.

In an exemplary embodiment, the front reflector wing 340 is planar. However, the front reflector wing 340 may be curved, such as front to rear and/or side to side. In an exemplary embodiment, the front reflector wing 340 is bent at an angle relative to the main reflector panel 310. The front reflector wing 340 is angled non-coplanar with the main reflector panel 310. For example, the front reflector wing 340 is bent upward at an oblique angle relative to the main reflector panel 310. The upward taper of the front reflector wing 340 provides different spacing to the antenna element 210 to control the antenna radiation pattern. For example, angling the front reflector wing 340 toward the antenna element 210 may harmonize the radiation pattern between the low band and the high band. In the illustrated embodiment, the front reflector wing 340 is generally rectangular. However, the front reflector wing 340 may have other shapes in alternative embodiments, such as being trapezoidal or having another shape. The front reflector wing 340 includes a front 342 and a rear 344. The rear 344 is connected to the front 312 of the main reflector panel 310 at a bend 345. The front reflector wing 340 extends between a first side 346 and a second side 348. In an exemplary embodiment, at least portions of the first and second sides 346, 348 are tapered relative to each other, such as being closer at the front 342 then the rear 344. However, in alternative embodiments, the first and second sides 346, 348 may be parallel to each other. The front reflector wing 340 has a width between the first and second sides 346, 348. The width may be variable, such as narrower at the front 342 and wider at the rear 344. The front reflector wing 340 has a length between the front 342 and the rear 344. The length may be variable, such as being wider at the center and narrower at the sides. The width and the length may be selected based on the width and the length of the radome 110. The width and the length may be selected based on the width and the length of the antenna element 210. For example, the width and/or the length may be selected based on the positioning of the high band antenna 230 and/or the positioning of the low band antenna 240. In an exemplary embodiment, the front reflector wing 340 is configured to be aligned with the low band antenna 240. For example, the high band antenna 230 does not extend over the front reflector wing 340.

In an exemplary embodiment, the front reflector wing 340 includes a recess 350 formed in the front reflector wing 340. The recess 350 may be formed during stamping of the forward inner wall 334. The recess 350 may be aligned with the low band antenna 240. The recess 350 may be used to control the reflective characteristics of the reflector 300, such as to control the antenna pattern. For example, the recess 350 may improve the radiation pattern for the low band antenna 240. The size and shape of the recess may be selected for low band radiation pattern control. The front reflector wing 340 may include other slots or openings in addition to the recess 350 in alternative embodiments. For example, the front reflector wing 340 includes openings 352 configured to receive support posts of the radome 110 used to support the reflector 300 relative to the radome 110.

The front sidewalls 360, 362 extend along the first and second sides 346, 348, respectively, of the front reflector wing 340. In an exemplary embodiment, the front sidewalls 360, 362 are extended forward from the main sidewalls 330, 332. For example, the front sidewalls 360, 362 may be stamped with the main sidewalls 330, 332. In alternative embodiments, the front sidewalls 360, 362 may extend from the front reflector wing 340. For example, the front sidewalls 360, 362 may be stamped with the front reflector wing 340. The front sidewalls 360, 362 have a variable height. For example, the front sidewalls 360, 362 may be tapered from the rear to the front. The front sidewalls 360, 362 may be tapered at an angle to match the bend angle of the front reflector wing 340 relative to the main reflector panel 310. In an exemplary embodiment, the height of the first front sidewall 360 is the same as the height of the second front sidewall 362. However, in alternative embodiments, the heights of the front sidewalls 360, 362 may be different than each other. In various embodiments, the front sidewalls 360, 362 may include one or more slots (not shown), which may be open at the bottom and/or the top and/or the sides. The front sidewalls 360, 362 provide antenna pattern control of the azimuth plane beamwidth.

In an exemplary embodiment, the rear reflector wing 370 is planar. However, the rear reflector wing 370 may be curved, such as front to rear and/or side to side. In an exemplary embodiment, the rear reflector wing 370 is bent at an angle relative to the main reflector panel 310. The rear reflector wing 370 is angled non-coplanar with the main reflector panel 310. For example, the rear reflector wing 370 is bent upward at an oblique angle relative to the main reflector panel 310. The upward taper of the rear reflector wing 370 provides different spacing to the antenna element 210 to control the antenna radiation pattern. For example, angling the rear reflector wing 370 toward the antenna element 210 may harmonize the radiation pattern between the low band and the high band. In the illustrated embodiment, the rear reflector wing 370 is generally trapezoidal. However, the rear reflector wing 370 may have other shapes in alternative embodiments, such as being rectangular, triangular, or having another shape. The rear reflector wing 370 includes a front 372 and a rear 374. The front 372 is connected to the rear 314 of the main reflector panel 310 at a bend 375. The rear reflector wing 370 extends between a first side 376 and a second side 378. In an exemplary embodiment, at least portions of the first and second sides 376, 378 are tapered relative to each other, such as being closer at the rear 374 than at the front 372. However, in alternative embodiments, the first and second sides 376, 378 may be parallel to each other. The rear reflector wing 370 has a width between the first and second sides 376, 378. The width may be variable, such as narrower at the rear 374 and wider at the front 372. The rear reflector wing 370 has a length between the front 372 and the rear 374. The length may be variable, such as being wider at the center and narrower at the sides. The width and the length may be selected based on the width and the length of the radome 110. The width and the length may be selected based on the width and the length of the antenna element 210. For example, the width and/or the length may be selected based on the positioning of the high band antenna 230 and/or the positioning of the low band antenna 240. In an exemplary embodiment, the rear reflector wing 370 is configured to be aligned with the low band antenna 240. For example, the high band antenna 230 does not extend over the rear reflector wing 370.

In an exemplary embodiment, the rear reflector wing 370 includes a recess 380 formed in the rear reflector wing 370. The recess 380 may be formed during stamping of the rearward inner wall 334. The recess 380 may be aligned with the low band antenna 240. The recess 380 may be used to control the reflective characteristics of the reflector 300, such as to control the antenna pattern. For example, the recess 380 may improve the radiation pattern for the low band antenna 240. The size and shape of the recess may be selected for low band radiation pattern control. The rear reflector wing 370 may include other slots or openings in addition to the recess 380 in alternative embodiments. For example, the rear reflector wing 370 includes openings 382 configured to receive support posts of the radome 110 used to support the reflector 300 relative to the radome 110. The rear reflector wing 370 may include a slot 384 extending from the rear 374 to the recess 380. The slot 384 is configured to receive the coaxial cable 154 such as to allow the coaxial cable 154 to pass through the reflector 300 during assembly.

The rear sidewalls 390, 392 extend along the first and second sides 376, 378, respectively, of the rear reflector wing 370. In an exemplary embodiment, the rear sidewalls 390, 392 are extended rearward from the main sidewalls 330, 332. For example, the rear sidewalls 390, 392 may be stamped with the main sidewalls 330, 332. In alternative embodiments, the rear sidewalls 390, 392 may extend from the rear reflector wing 370. For example, the rear sidewalls 390, 392 may be stamped with the rear reflector wing 370. In an exemplary embodiment, the rear sidewalls 390, 392 may include one or more angles or bends, such as to match the shape of the sides 376, 378 of the rear reflector wing 370. The rear sidewalls 390, 392 have a variable height. For example, the rear sidewalls 390, 392 may be tapered from the front to the rear. The rear sidewalls 390, 392 may be tapered at an angle to match the bend angle of the rear reflector wing 370 relative to the main reflector panel 310. In an exemplary embodiment, the height of the first rear sidewall 390 is the same as the height of the second rear sidewall 392. However, in alternative embodiments, the heights of the rear sidewalls 390, 392 may be different than each other. In various embodiments, the rear sidewalls 390, 392 may include one or more slots (not shown), which may be open at the bottom and/or the top and/or the sides. The rear sidewalls 390, 392 provide antenna pattern control of the azimuth plane beamwidth.

The reflector 300 has a concave shape that faces the antenna element 210. Generally, the high band antenna 230 is aligned with the central main section of the reflector 300 and the low band antenna 240 extends over the front and rear reflector wings 340, 370. The main reflector panel 310, main sidewalls 330, 332, and forward and rearward inner walls 334, 336 are sized/shaped/positioned to shape the high band beamwidth. The front and rear reflector wings 340, 370 and front and rear sidewalls 360, 362, 390, 392 are sized/shaped/positioned to shape the low band beamwidth. The front and rear sidewalls 360, 362, 390, 392 may have different heights compared to the main sidewalls 330, 332 for different band beamwidth control (for example, low band versus high band). The main sidewalls 330, 332 and the forward and rearward inner wall 334, 336 heights control the beamwidth in the azimuth and elevation respectively. Optionally, one of the inner walls 334 or 336 can be a different height to compensate for the asymmetrical structure in elevation to improve the asymmetrical radiation pattern. The overall length of the reflector 300 is designed to improve the front-to-back ratio and the narrower elevation beamwidth. Adding the recesses 350, 380 forward and rearward of the main reflector panel 310 along the bent or angled front and rear reflector wings 340, 370 helps the low band radiation pattern performance. Slots are used to make ease of the manufacturing and assembly of the antenna assembly 200, such as to allow assembly to the antenna feed 150 and the coaxial cable 154.

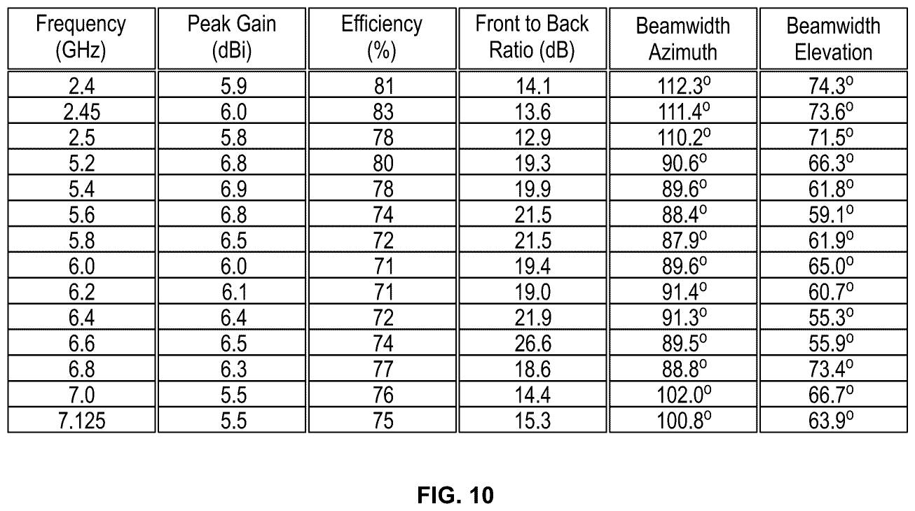

FIG. 10 is a chart showing performance summary of the antenna 100 shown in FIGS. 6-8 using the reflector shown in FIG. 9. The antenna 100 is a multiband antenna. In the illustrated embodiment, the antenna 100 covers the 2.4 GHz Wi-Fi band, the 5 GHz Wi-Fi band, and the 6 GHz Wi-Fi band. The chart performance data at multiple frequencies in the 2.4 GHz Wi-Fi band, the 5 GHz Wi-Fi band, and the 6 GHz Wi-Fi band. The chart shows performance characteristics including Peak Gain (dBi), Efficiency (%), Front-to-Back Ratio (dB), Beamwidth—Azimuth, and Beamwidth—Elevation. The antenna with the reflector provides wide beamwidth (for example, wide azimuth beamwidth on the order of 90° and elevation beamwidth on the order of) 60° for multi-band operation with low variation across a wide frequency range. The antenna and reflector provide efficient gain on the order of 6 dBi with good front-to-back ration of better than 12.8 dB.

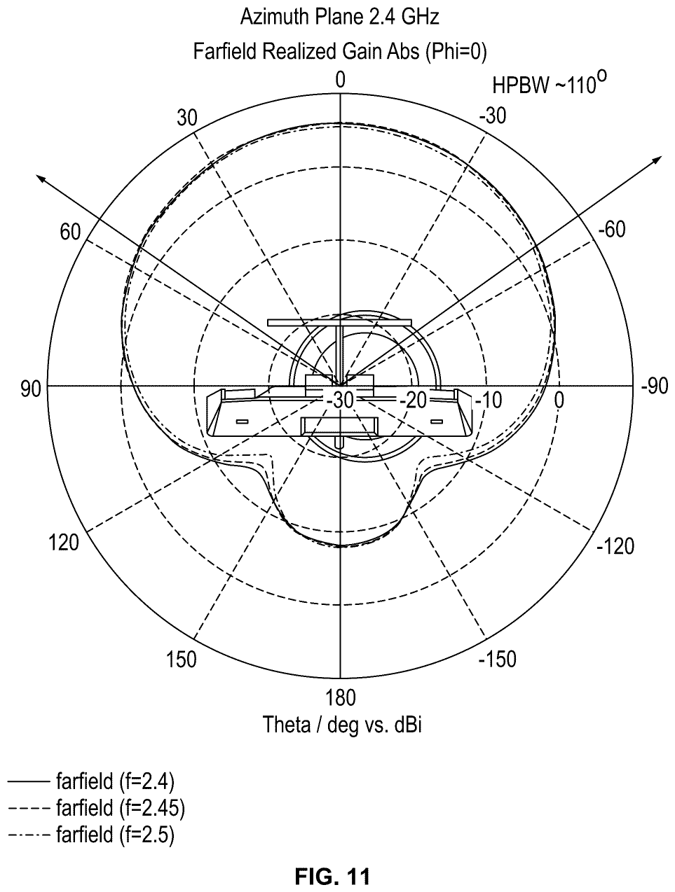

FIG. 11 shows the antenna radiation pattern in the Azimuth plane at the low band for the antenna 100 shown in FIGS. 6-8 using the reflector shown in FIG. 9. The antenna provides wide beamwidth with low variation across a wide frequency range. The results shown in FIG. 11 are provided for purposes of illustration and not for purposes of limitation. Alternative embodiments of the antenna and reflector may be configured differently and have different operational or performance parameters than what is shown in FIG. 11.

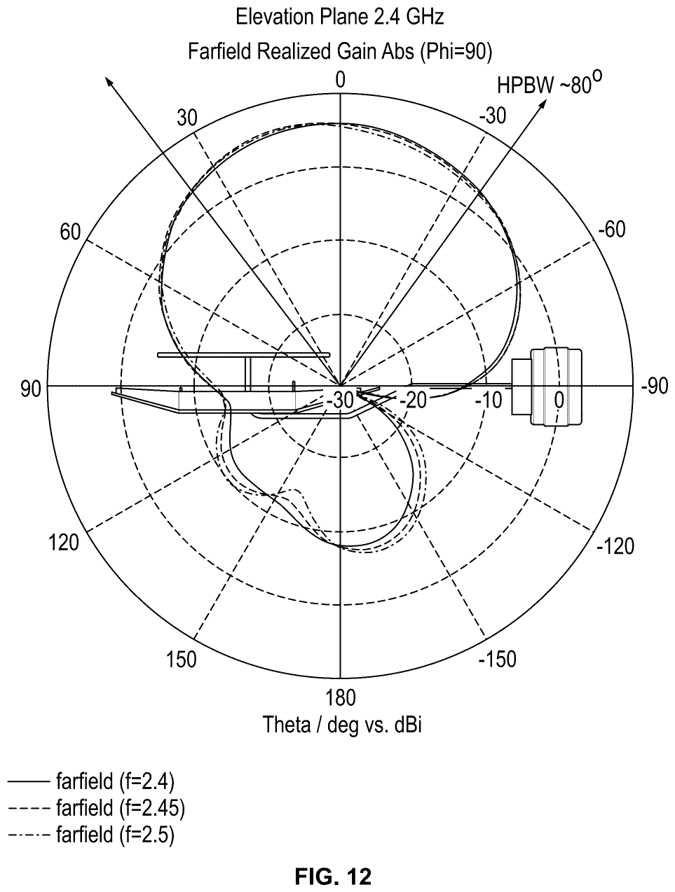

FIG. 12 shows the antenna radiation pattern in the Elevation plane at the low band for the antenna 100 shown in FIGS. 6-8 using the reflector shown in FIG. 9. The antenna provides wide beamwidth with low variation across a wide frequency range. The results shown in FIG. 12 are provided for purposes of illustration and not for purposes of limitation. Alternative embodiments of the antenna and reflector may be configured differently and have different operational or performance parameters than what is shown in FIG. 12.

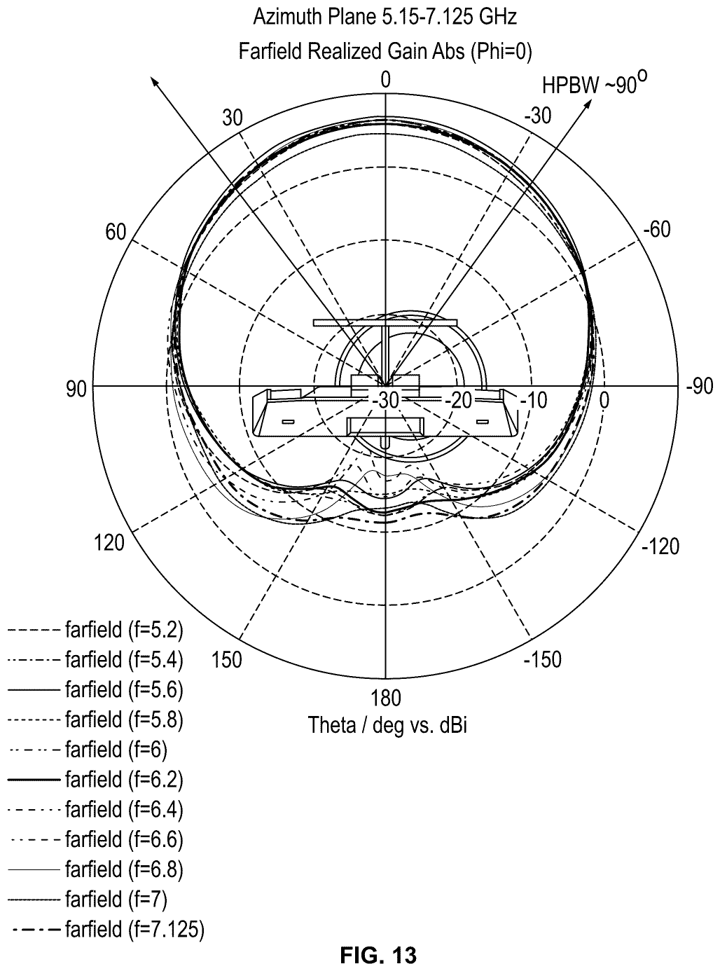

FIG. 13 shows the antenna radiation pattern in the Azimuth plane at the high band for the antenna 100 shown in FIGS. 6-8 using the reflector shown in FIG. 9. The antenna provides wide beamwidth with low variation across a wide frequency range. The results shown in FIG. 13 are provided for purposes of illustration and not for purposes of limitation. Alternative embodiments of the antenna and reflector may be configured differently and have different operational or performance parameters than what is shown in FIG. 13.

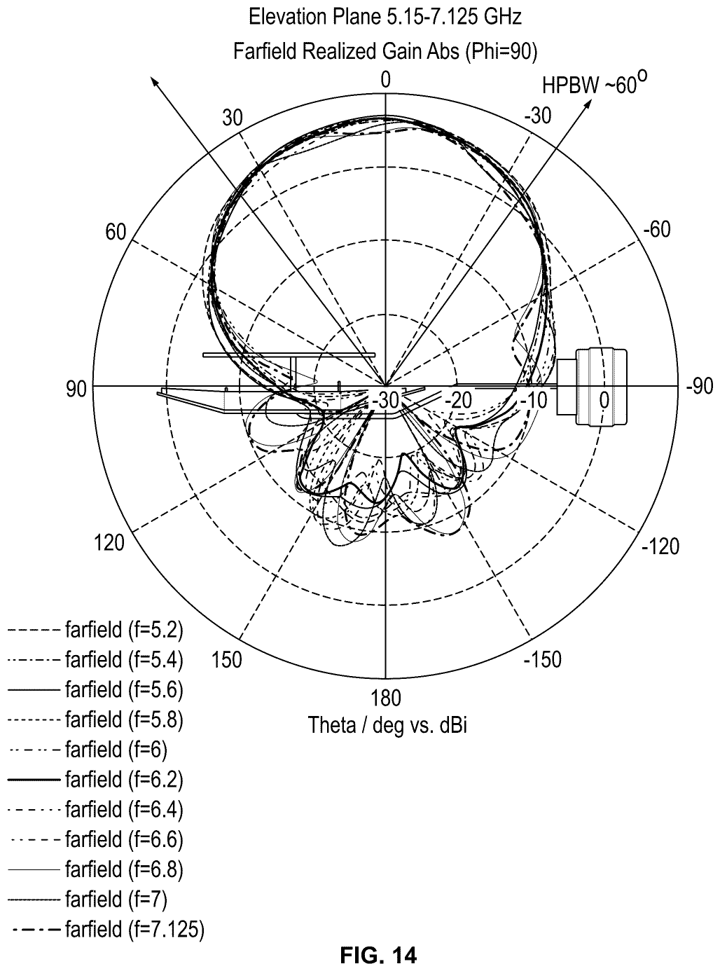

FIG. 14 shows the antenna radiation pattern in the Elevation plane at the high band for the antenna 100 shown in FIGS. 6-8 using the reflector shown in FIG. 9. The antenna provides wide beamwidth with low variation across a wide frequency range. The results shown in FIG. 14 are provided for purposes of illustration and not for purposes of limitation. Alternative embodiments of the antenna and reflector may be configured differently and have different operational or performance parameters than what is shown in FIG. 14.

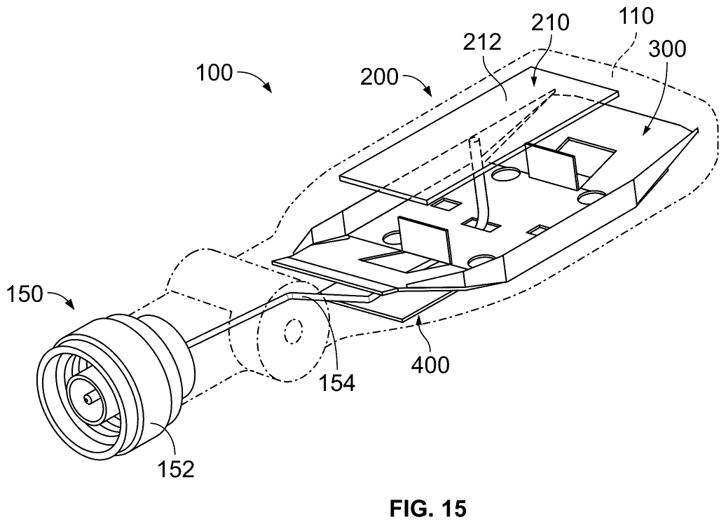

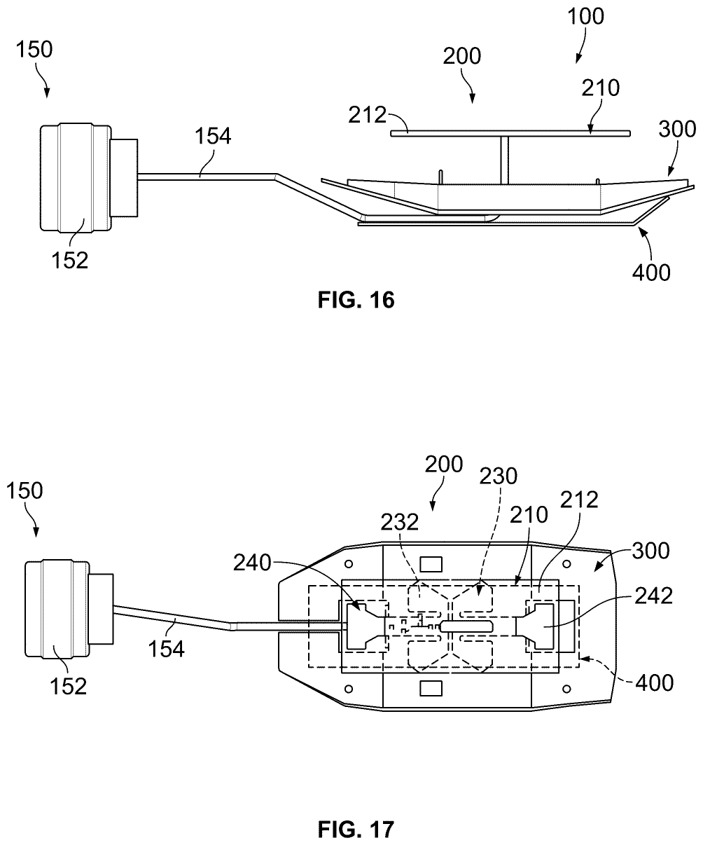

FIG. 15 is a perspective view of the antenna assembly 200 in accordance with an exemplary embodiment. FIG. 16 is a side view of the antenna assembly 200 in accordance with an exemplary embodiment. FIG. 17 is a top view of the antenna assembly 200 in accordance with an exemplary embodiment. FIGS. 15-17 illustrate the antenna feed 150 coupled to the antenna assembly 200. For example, the RF connector 152 of the antenna feed 150 is coupled to the antenna assembly 200 by the coaxial cable 154. FIGS. 15-17 illustrate the antenna assembly 200 including a secondary reflector 400 separate and discrete from the primary reflector 300. The secondary reflector 400 improves the antenna performance. For example, the secondary reflector 400 may improve the front-to-back ratio. The secondary reflector 400 may improve the peak gain. The secondary reflector 400 may improve the beam width in the Azimuth plane and/or the Elevation plane. The secondary reflector 400 may improve the beam direction in the Azimuth plane and/or the Elevation plane.

The antenna assembly 200 includes the multiband antenna element 210, the reflector 300 spaced from the antenna element 210 and facing the antenna element 210, and the secondary reflector 400 spaced from the antenna element 210 and facing the antenna element 210. In an exemplary embodiment, the reflector 300 is located between the secondary reflector 400 and the antenna element 210. For example, the secondary reflector 400 is located at the bottom of the antenna 100, such as at the bottom of the radome 110, and the antenna element 210 is located at the top of the antenna 100, such as at the top of the radome 110. The reflector 300 is suspended in the middle of the radome 110 between the antenna element 210 and the secondary reflector 400. The secondary reflector 400 may be a stamped and formed part. For example, the reflector 300 may be stamped from a metal sheet and formed into a particular shape designed to control and improve performance of the multiband antenna element 210. In other various embodiments, the secondary reflector 400 may be a film applied to the inner surface of the radome 110 at the bottom. In alternative embodiments, the secondary reflector 400 may be a plating layer plated to the inner surface of the radome 110. In an exemplary embodiment, the secondary reflector 400 provides antenna pattern control, such as to provide wide beam width, to control antenna gain, and to improve the front-to-back ratio of the antenna element 210. In an exemplary embodiment, the secondary reflector 400 is sized/shaped/spaced to the antenna element 210 to harmonize the radiation pattern, such as between a low band and a high band of the antenna element 210. In an exemplary embodiment, the secondary reflector 400 is designed to provide a generally symmetrical radiation pattern for the antenna element 210.

The antenna element 210 includes the high band antenna 230 and the low band antenna 240. In an exemplary embodiment, the low band antenna 240 is operable at frequency ranges of between 2.4 and 2.5 GHz and the high band antenna 230 is operable at frequency ranges of between 5.15 and 7.125 GHz. In an exemplary embodiment, the antenna element 210 includes the antenna printed circuit board 212 and the high band antenna 230 and the low band antenna 240 are defined by circuits of the antenna printed circuit board 212. In alternative embodiments, the antenna element 210 may be provided without the antenna printed circuit board 212. Rather, the antenna element 210 may include stamped metal elements or other types of conductive elements defining radiating elements of the antenna element 210. The high band antenna 230 includes the high band radiating arms 232. The low band antenna 240 includes the low band radiating arms 242.

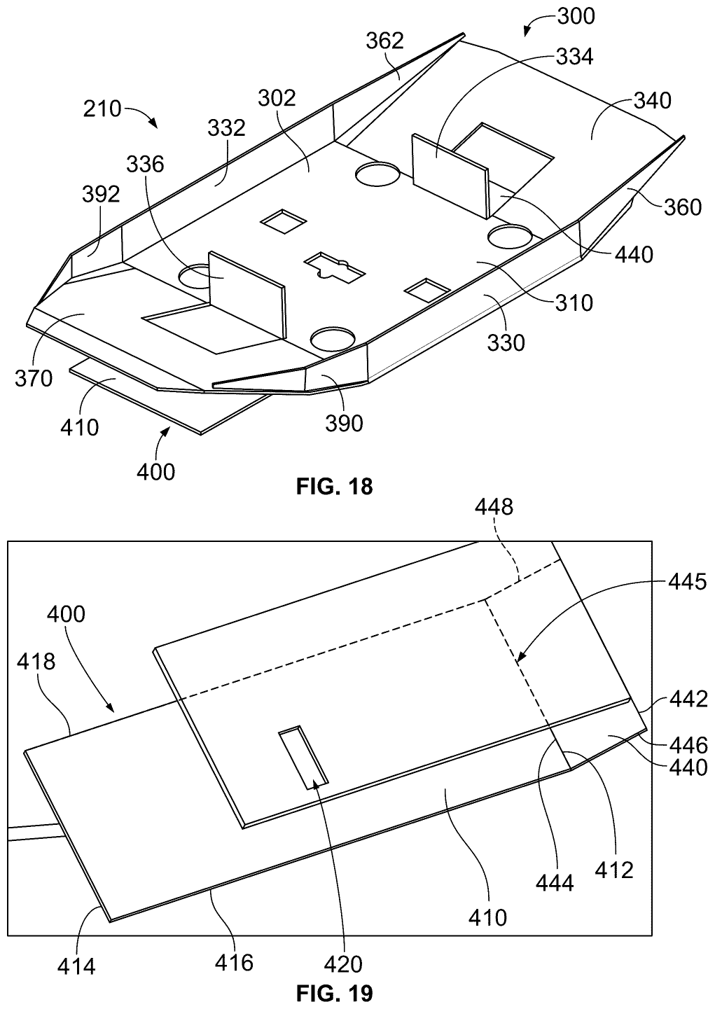

FIG. 18 is a perspective view of the reflector 300 and the secondary reflector 400 in accordance with an exemplary embodiment. FIG. 19 is a perspective view of the secondary reflector 400 in accordance with an exemplary embodiment with the reflector 300 removed to illustrate the parts of the secondary reflector 400. The secondary reflector 400 is located below the primary reflector 300.

The reflector 300 includes the panels 302 forming the concave shape of the reflector 300. The reflector 300 includes the main reflector panel 310, the front reflector wing 340 forward of the main reflector panel 310, and the rear reflector wing 370 rearward of the main reflector panel 310. The reflector 300 includes the main sidewalls 330, 332 on opposite sides of the main reflector panel 310, the front sidewalls 360, 362 on opposite sides of the front reflector wing 340, and the rear sidewalls 390 392 on opposite sides of the rear reflector wing 370. The reflector 300 includes the forward inner wall 334 and the rearward inner wall 336.

The secondary reflector 400 includes a main panel 410 and a wing panel 440 extending from the main panel 410. The secondary reflector 400 may include additional panels in other various embodiments, such as wing panels at both ends of the main panel 410 and/or side panels extending along side(s) of the main panel 410, changing the shape of the secondary reflector 400. The secondary reflector 400 improves front-to-back ratio while maintaining wide azimuth beamwidth.

In an exemplary embodiment, the main panel 410 is planar. However, the main panel 410 may be curved, such as front to rear and/or side to side. In the illustrated embodiment, the main panel 410 is generally rectangular. However, the main panel 410 may have other shapes in alternative embodiments. The main panel 410 includes a front 412 and a rear 414. The main panel 410 extends between a first side 416 and a second side 418. In an exemplary embodiment, the first and second sides 416, 418 are parallel to each other. Optionally, the first and second sides 416, 418 may be perpendicular to the front 412 and/or the rear 414. The main panel 410 has a width between the first and second sides 416, 418. The main panel 410 has a length between the front 412 and the rear 414. The width and the length may be selected based on the width and the length of the radome 110, such as the main portion 108 of the radome 110. The width and the length may be selected based on the width and the length of the antenna element 210. For example, the width and/or the length may be selected based on the positioning of the high band antenna 230 and/or the positioning of the low band antenna 240. In an exemplary embodiment, the width of the main panel 410 is narrower than the width of the main reflector panel 310 of the reflector 300. The length of the main panel 410 may be longer than the length of the main reflector panel 310 of the reflector 300. In an exemplary embodiment, the length of the main panel 410 is longer than the length of the high band antenna 230 to provide reflective cover for the low band antenna 240. In various embodiments, the main panel 410 may include slots 420 formed in the main panel 410. The slots 420 may allow components to pass through the main panel 410. The slots 420 may receive portions of the radome 110, such as support walls used to support the reflector 300 and/or the antenna element 210. The slots 420 may be used to control the reflective characteristics of the secondary reflector 400, such as to control the antenna pattern. In various embodiments, the secondary reflector 400 may include sidewalls (not shown) extending from the first and second sides 416, 418, respectively, to provide antenna pattern control, such as to control the azimuth plane beamwidth.

The wing panel 440 extends from the main panel 410, such as from the front 412. In an exemplary embodiment, the wing panel 440 is planar. However, the wing panel 440 may be curved, such as front to rear and/or side to side. In an exemplary embodiment, the wing panel 440 is bent at an angle relative to the main reflector panel 410. The wing panel 440 is angled non-coplanar with the main reflector panel 410. For example, the wing panel 440 is bent upward at an oblique angle relative to the main reflector panel 410. The upward taper of the wing panel 440 provides different spacing to the antenna element 210 to control the antenna radiation pattern. Angling the wing panel 440 increases the overall length of the secondary reflector 400. The angle of the wing panel 440 may correspond to the shape of the radome 110, such as following a contour or angle of the radome 110. In the illustrated embodiment, the wing panel 440 is generally rectangular. However, the wing panel 440 may have other shapes in alternative embodiments, such as being trapezoidal or having another shape. The wing panel 440 includes a front 442 and a rear 444. The rear 444 is connected to the front 412 of the main reflector panel 410 at a bend 445. The wing panel 440 extends between a first side 446 and a second side 448. The first and second sides 446, 448 may be parallel to each other. However, the first and second sides 446, 448 may be tapered, such as to correspond to the shape of the radome 110. In various embodiments, the wing panel 440 may include openings, slots or recesses, such as to control the reflective characteristics of the secondary reflector 400 and/or to accommodate portions of the radome 110. In various embodiments, the secondary reflector 400 may include sidewalls (not shown) extending along the sides 446, 448 of the wing panel 440 to provide antenna pattern control, such as to control the azimuth plane beamwidth.

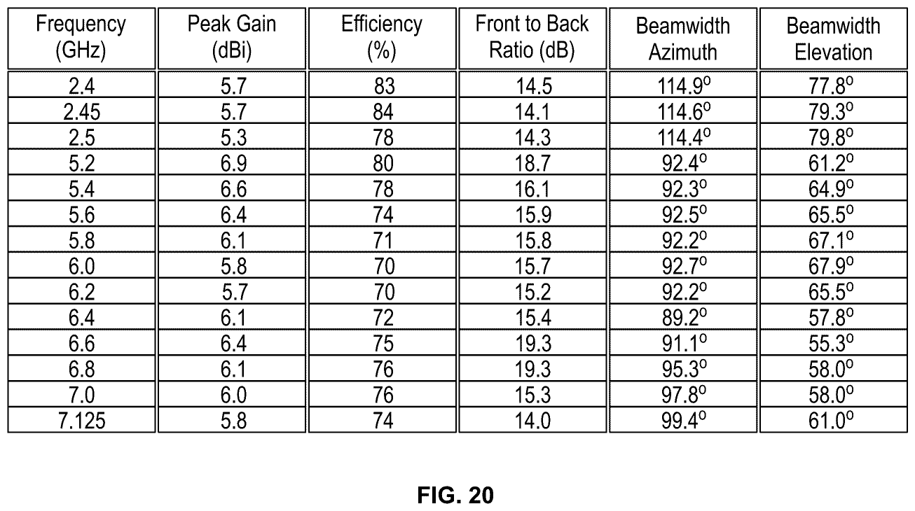

FIG. 20 is a chart showing performance summary of the antenna 100 shown in FIGS. 15-17 using the reflector shown in FIG. 18 and the secondary reflector 400 shown in FIG. 19. The antenna 100 is a multiband antenna. In the illustrated embodiment, the antenna 100 covers the 2.4 GHz Wi-Fi band, the 5 GHz Wi-Fi band, and the 6 GHz Wi-Fi band. The chart performance data at multiple frequencies in the 2.4 GHz Wi-Fi band, the 5 GHz Wi-Fi band, and the 6 GHz Wi-Fi band. The chart shows performance characteristics including Peak Gain (dBi), Efficiency (%), Front-to-Back Ratio (dB), Beamwidth—Azimuth, and Beamwidth—Elevation. The antenna with the reflector provides wide beamwidth (for example, wide azimuth beamwidth on the order of 90° and elevation beamwidth on the order of) 60° for multi-band operation with low variation across a wide frequency range. The antenna and reflector provide efficient gain on the order of 6 dBi with good front-to-back ration of better than 14 dB.

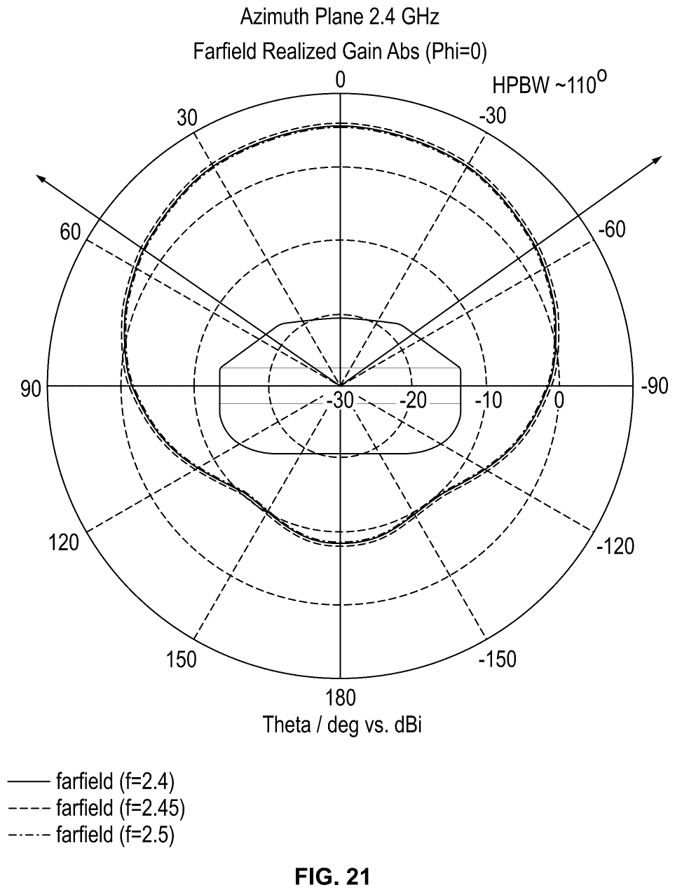

FIG. 21 shows the antenna radiation pattern in the Azimuth plane at the low band for the antenna 100 shown in FIGS. 15-17 using the reflector shown in FIG. 18 and the secondary reflector 400 shown in FIG. 19. The antenna provides wide beamwidth with low variation across a wide frequency range. The results shown in FIG. 21 are provided for purposes of illustration and not for purposes of limitation. Alternative embodiments of the antenna and reflector may be configured differently and have different operational or performance parameters than what is shown in FIG. 21.

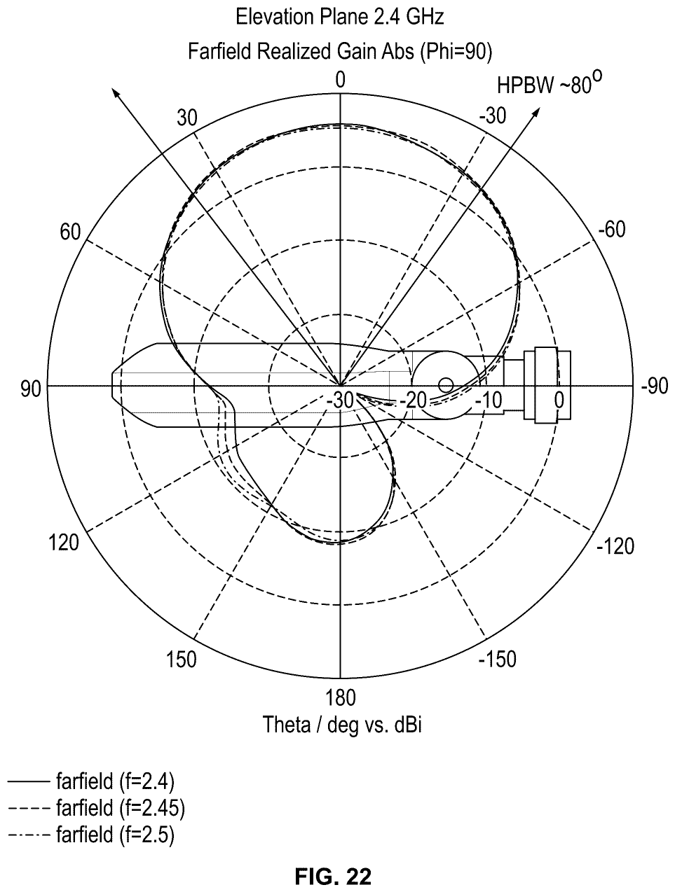

FIG. 22 shows the antenna radiation pattern in the Elevation plane at the low band for the antenna 100 shown in FIGS. 15-17 using the reflector shown in FIG. 18 and the secondary reflector 400 shown in FIG. 19. The antenna provides wide beamwidth with low variation across a wide frequency range. The results shown in FIG. 22 are provided for purposes of illustration and not for purposes of limitation. Alternative embodiments of the antenna and reflector may be configured differently and have different operational or performance parameters than what is shown in FIG. 22.

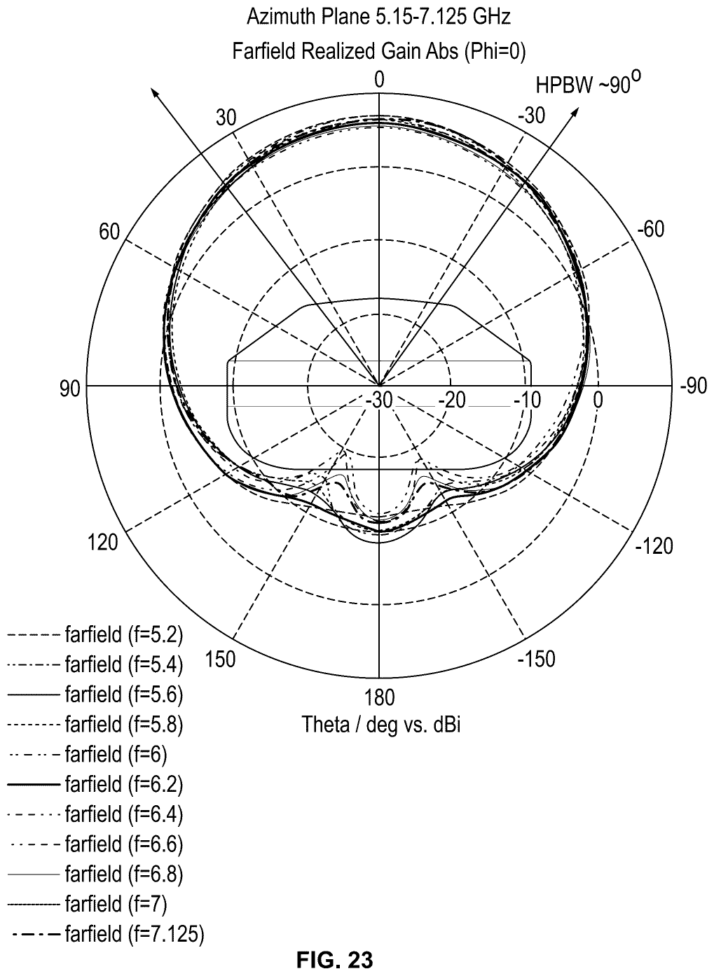

FIG. 23 shows the antenna radiation pattern in the Azimuth plane at the high band for the antenna 100 shown in FIGS. 15-17 using the reflector shown in FIG. 18 and the secondary reflector 400 shown in FIG. 19. The antenna provides wide beamwidth with low variation across a wide frequency range. The results shown in FIG. 23 are provided for purposes of illustration and not for purposes of limitation. Alternative embodiments of the antenna and reflector may be configured differently and have different operational or performance parameters than what is shown in FIG. 23.

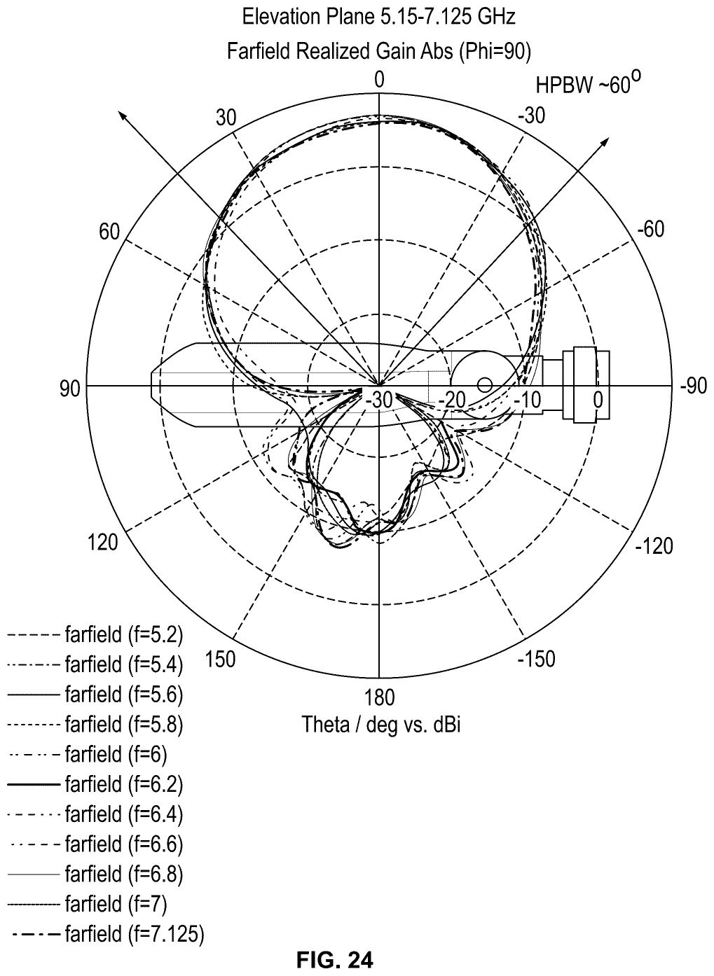

FIG. 24 shows the antenna radiation pattern in the Elevation plane at the high band for the antenna 100 shown in FIGS. 15-17 using the reflector shown in FIG. 18 and the secondary reflector 400 shown in FIG. 19. The antenna provides wide beamwidth with low variation across a wide frequency range. The results shown in FIG. 24 are provided for purposes of illustration and not for purposes of limitation. Alternative embodiments of the antenna and reflector may be configured differently and have different operational or performance parameters than what is shown in FIG. 24.

Further, the disclosure comprises examples according to the following clauses:

Clause 1. An antenna comprising:
a radome having walls forming a chamber, the radome having a top, a bottom, a front, a rear, a first side, and a second side; and
an antenna assembly received in the chamber, the antenna assembly including a multiband antenna element and a reflector spaced from the antenna element and facing the antenna element;
the multiband antenna element including a high band antenna including high band radiating arms;
the multiband antenna element including a low band antenna including low band radiating arms;
the reflector including a main reflector panel, a front reflector wing forward of the main reflector panel, a rear reflector wing rearward of the main reflector panel, main sidewalls on opposite sides of the main reflector panel, front sidewalls on opposite sides of the front reflector wing, rear sidewalls on opposite sides of the rear reflector wing, a forward inner wall at the interface of the main reflector panel and the front reflector wing, and a rearward inner wall at the interface of the main reflector panel and the rear reflector wing.

Clause 2. The antenna of clause 1, wherein the front reflector wing is angled non-coplanar with the main reflector panel, the rear reflector wing being angled non-coplanar with the main reflector panel.

Clause 3. The antenna of any of clauses 1-2, wherein the front reflector wing is connected to the main reflector panel at a bend, the front reflector wing being bent upward at an oblique angle relative to the main reflector panel, the rear reflector wing being connected to the main reflector panel at a bend, the rear reflector wing being bent upward at an oblique angle relative to the main reflector panel.

Clause 4. The antenna of any of clauses 1-3, wherein the main sidewalls have different heights compared to the front sidewalls and the rear sidewalls.

Clause 5. The antenna of any of clauses 1-4, wherein the forward inner wall and the rearward inner wall have different heights.

Clause 6. The antenna of any of clauses 1-5, wherein the front reflector wing includes a forward recess aligned with the forward inner wall, the rear reflector wing including a rearward recess aligned with the rearward inner wall.

Clause 7. The antenna of any of clauses 1-6, wherein the forward inner wall is parallel to the rearward inner wall, the main sidewalls being oriented perpendicular to the forward and rearward inner walls.

Clause 8. The antenna of any of clauses 1-7, further comprising a secondary reflector spaced from the multiband antenna element, the secondary reflector including a central panel aligned with the high band radiating arms and the low band radiating arms.

Clause 9. The antenna of clause 8, wherein the reflector is positioned between the secondary reflector and the multiband antenna element.

Clause 10. The antenna of clause 8, wherein the secondary reflector includes a main panel and a wing panel extending from the main panel at an oblique angle.

Clause 11. The antenna of clause 8, wherein the secondary reflector is coupled to an interior surface of the bottom of the radome, the reflector being suspended in the chamber between the top and the bottom of the radome, the multiband antenna element located proximate to the top of the radome.

Clause 12. The antenna of any of clauses 1-11, wherein the high band radiating arms are aligned with the main reflector panel, the low band radiating arms being aligned with the main reflector panel, the front reflector wing, and the rear reflector wing.

Clause 13. The antenna of any of clauses 1-12, wherein the high band antenna is a dipole antenna, the low band antenna being a dipole antenna.

Clause 14. The antenna of any of clauses 1-13, wherein the antenna assembly includes an antenna printed circuit board, the high band radiating arms formed on one or more layers of the antenna printed circuit board, the low band radiating arms formed on one or more layers of the antenna printed circuit board.

Clause 15. The antenna of any of clauses 1-14, wherein the antenna assembly includes a balun coupling radiating element.

Clause 16. The antenna of any of clauses 1-15, wherein the antenna assembly includes lump components.

Clause 17. The antenna of any of clauses 1-16, further comprising an antenna feed including an RF connector and a coaxial cable coupled to a feed of the antenna assembly.

Clause 18. The antenna of clause 17, wherein the reflector includes a slot receiving the coaxial cable allowing the coaxial cable to pass through the reflector.

Clause 19. The antenna of any of clauses 1-18, wherein the antenna assembly has a wide azimuth beamwidth wider than 90° and an elevation beamwidth wider than 60°.

Clause 20. The antenna of any of clauses 1-19, wherein the high band antenna is operable at a frequency range of between 5.15 and 7.125 GHz and the low band antenna is operable at a frequency range of between 2.4 and 2.5 GHz.

Clause 21. The antenna of any of clauses 1-20, wherein the reflector has a variable spacing to the multiband antenna element from front-to-rear.

Clause 22. The antenna of clause 21, wherein the front reflector wing and the rear reflector wing are closer to the multiband antenna element and the main reflector panel.

Clause 23. An antenna assembly comprising:
a multiband antenna element including a high band antenna including high band radiating arms and a low band antenna including low band radiating arms; and
a reflector spaced from the multiband antenna element and facing the antenna element, the reflector including a main reflector panel, a front reflector wing forward of the main reflector panel, a rear reflector wing rearward of the main reflector panel, main sidewalls on opposite sides of the main reflector panel, front sidewalls on opposite sides of the front reflector wing, rear sidewalls on opposite sides of the rear reflector wing, a forward inner wall at the interface of the main reflector panel and the front reflector wing, and a rearward inner wall at the interface of the main reflector panel and the rear reflector wing.

Clause 24. An antenna assembly comprising:
a multiband antenna element including a high band antenna including high band radiating arms and a low band antenna including low band radiating arms;
a reflector spaced from the multiband antenna element and facing the antenna element, the reflector including a main reflector panel, a front reflector wing forward of the main reflector panel, a rear reflector wing rearward of the main reflector panel, main sidewalls on opposite sides of the main reflector panel, front sidewalls on opposite sides of the front reflector wing, rear sidewalls on opposite sides of the rear reflector wing, a forward inner wall at the interface of the main reflector panel and the front reflector wing, and a rearward inner wall at the interface of the main reflector panel and the rear reflector wing; and
a secondary reflector spaced from the multiband antenna element, the secondary reflector including a central panel aligned with the high band radiating arms and the low band radiating arms.

Clause 25. The antenna assembly of clause 24, wherein the reflector is positioned between the secondary reflector and the multiband antenna element.

Clause 26. The antenna assembly of any of clauses 24-25, wherein the secondary reflector includes a main panel and a wing panel extending from the main panel at an oblique angle.

Clause 27. The antenna assembly of any of clauses 24-26, wherein the secondary reflector is coupled to an interior surface of the bottom of the radome, the reflector being suspended in the chamber between the top and the bottom of the radome, the multiband antenna element located proximate to the top of the radome.

Clause 28. The antenna assembly of any of clauses 24-27, wherein the front reflector wing is angled non-coplanar with the main reflector panel, the rear reflector wing being angled non-coplanar with the main reflector panel.

Clause 29. The antenna assembly of any of clauses 24-28, wherein the front reflector wing is connected to the main reflector panel at a bend, the front reflector wing being bent upward at an oblique angle relative to the main reflector panel, the rear reflector wing being connected to the main reflector panel at a bend, the rear reflector wing being bent upward at an oblique angle relative to the main reflector panel.

Clause 30. The antenna assembly of any of clauses 24-29, wherein the main sidewalls have different heights compared to the front sidewalls and the rear sidewalls.

Clause 31. The antenna assembly of any of clauses 24-30, wherein the forward inner wall and the rearward inner wall have different heights.

Clause 32. The antenna assembly of any of clauses 24-31, wherein, the rear reflector wing including a rearward recess aligned with the rearward inner wall.

Clause 33. The antenna assembly of any of clauses 24-32, wherein the forward inner wall is parallel to the rearward inner wall, the main sidewalls being oriented perpendicular to the forward and rearward inner walls.

Clause 34. The antenna assembly of any of clauses 24-33, wherein the high band radiating arms are aligned with the main reflector panel, the low band radiating arms being aligned with the main reflector panel, the front reflector wing, and the rear reflector wing.

Clause 35. The antenna assembly of any of clauses 24-34, wherein the high band antenna is a dipole antenna, the low band antenna being a dipole antenna.

Clause 36. The antenna assembly of any of clauses 24-35, wherein the antenna assembly includes an antenna printed circuit board, the high band radiating arms formed on one or more layers of the antenna printed circuit board, the low band radiating arms formed on one or more layers of the antenna printed circuit board.

Clause 37. The antenna assembly of any of clauses 24-36, wherein the antenna assembly includes a balun coupling radiating element.

Clause 38. The antenna assembly of any of clauses 24-37, wherein the antenna assembly includes lump components.

Clause 39. The antenna assembly of any of clauses 24-38, further comprising an antenna feed including an RF connector and a coaxial cable coupled to a feed of the antenna assembly.

Clause 40. The antenna assembly of clause 39, wherein the reflector includes a slot receiving the coaxial cable allowing the coaxial cable to pass through the reflector.

Clause 41. The antenna assembly of any of clauses 24-40, wherein the antenna assembly has a wide azimuth beamwidth wider than 90° and an elevation beamwidth wider than 60°.

Clause 42. The antenna assembly of any of clauses 24-41, wherein the high band antenna is operable at a frequency range of between 5.15 and 7.125 GHz and the low band antenna is operable at a frequency range of between 2.4 and 2.5 GHz.

Clause 43. The antenna assembly of any of clauses 24-42, wherein the reflector has a variable spacing to the multiband antenna element from front-to-rear.

Clause 44. The antenna assembly of clause 43, wherein the front reflector wing and the rear reflector wing are closer to the multiband antenna element and the main reflector panel.

Clause 45. The antenna assembly of clause 23, further comprising a secondary reflector spaced from the multiband antenna element, the secondary reflector including a central panel aligned with the high band radiating arms and the low band radiating arms.

Clause 46. The antenna assembly of clause 45, wherein the reflector is positioned between the secondary reflector and the multiband antenna element.

Clause 47. The antenna assembly of clause 45, wherein the secondary reflector includes a main panel and a wing panel extending from the main panel at an oblique angle.

Clause 48. The antenna assembly of clause 45, wherein the secondary reflector is coupled to an interior surface of the bottom of the radome, the reflector being suspended in the chamber between the top and the bottom of the radome, the multiband antenna element located proximate to the top of the radome.

Clause 49. The antenna assembly of any of clauses 23 and 45, wherein the front reflector wing is angled non-coplanar with the main reflector panel, the rear reflector wing being angled non-coplanar with the main reflector panel.

Clause 50. The antenna assembly of any of clauses 23 and 45-49, wherein the front reflector wing is connected to the main reflector panel at a bend, the front reflector wing being bent upward at an oblique angle relative to the main reflector panel, the rear reflector wing being connected to the main reflector panel at a bend, the rear reflector wing being bent upward at an oblique angle relative to the main reflector panel.

Clause 51. The antenna assembly of any of clauses 23 and 45-50, wherein the main sidewalls have different heights compared to the front sidewalls and the rear sidewalls.

Clause 52. The antenna assembly of any of clauses 23 and 45-51, wherein the forward inner wall and the rearward inner wall have different heights.

Clause 53. The antenna assembly of any of clauses 23 and 45-52, wherein, the rear reflector wing including a rearward recess aligned with the rearward inner wall.

Clause 54. The antenna assembly of any of clauses 23 and 45-53, wherein the forward inner wall is parallel to the rearward inner wall, the main sidewalls being oriented perpendicular to the forward and rearward inner walls.

Clause 55. The antenna assembly of any of clauses 23 and 45-54, wherein the high band radiating arms are aligned with the main reflector panel, the low band radiating arms being aligned with the main reflector panel, the front reflector wing, and the rear reflector wing.

Clause 56. The antenna assembly of any of clauses 23 and 45-55, wherein the high band antenna is a dipole antenna, the low band antenna being a dipole antenna.

Clause 57. The antenna assembly of any of clauses 23 and 45-56, wherein the antenna assembly includes an antenna printed circuit board, the high band radiating arms formed on one or more layers of the antenna printed circuit board, the low band radiating arms formed on one or more layers of the antenna printed circuit board.

Clause 58. The antenna assembly of any of clauses 23 and 45-57, wherein the antenna assembly includes a balun coupling radiating element.

Clause 59. The antenna assembly of any of clauses 23 and 45-58, wherein the antenna assembly includes lump components.

Clause 60. The antenna assembly of any of clauses 23 and 45-59, further comprising an antenna feed including an RF connector and a coaxial cable coupled to a feed of the antenna assembly.

Clause 61. The antenna assembly of clause 60, wherein the reflector includes a slot receiving the coaxial cable allowing the coaxial cable to pass through the reflector.

Clause 62. The antenna assembly of any of clauses 23 and 45-61, wherein the antenna assembly has a wide azimuth beamwidth wider than 90° and an elevation beamwidth wider than 60°.

Clause 63. The antenna assembly of any of clauses 23 and 45-62, wherein the high band antenna is operable at a frequency range of between 5.15 and 7.125 GHz and the low band antenna is operable at a frequency range of between 2.4 and 2.5 GHz.

Clause 64. The antenna assembly of any of clauses 23 and 45-63, wherein the reflector has a variable spacing to the multiband antenna element from front-to-rear.

Clause 65. The antenna assembly of clause 64, wherein the front reflector wing and the rear reflector wing are closer to the multiband antenna element and the main reflector panel.

It is to be understood that the above description is intended to be illustrative, and not restrictive. For example, the above-described embodiments (and/or aspects thereof) may be used in combination with each other. In addition, many modifications may be made to adapt a particular situation or material to the teachings of the invention without departing from its scope. Dimensions, types of materials, orientations of the various components, and the number and positions of the various components described herein are intended to define parameters of certain embodiments, and are by no means limiting and are merely exemplary embodiments. Many other embodiments and modifications within the spirit and scope of the claims will be apparent to those of skill in the art upon reviewing the above description. The scope of the invention should, therefore, be determined with reference to the appended claims, along with the full scope of equivalents to which such claims are entitled. In the appended claims, the terms “including” and “in which” are used as the plain-English equivalents of the respective terms “comprising” and “wherein.” Moreover, in the following claims, the terms “first,” “second,” and “third,” etc. are used merely as labels, and are not intended to impose numerical requirements on their objects. Further, the limitations of the following claims are not written in means—plus-function format and are not intended to be interpreted based on 35 U.S.C. § 112 (f), unless and until such claim limitations expressly use the phrase “means for” followed by a statement of function void of further structure.

What is claimed is:

1. An antenna comprising:
a radome having walls forming a chamber, the radome having a top, a bottom, a front, a rear, a first side, and a second side; and
an antenna assembly received in the chamber, the antenna assembly including a multiband antenna element and a reflector spaced from the antenna element and facing the antenna element;
the multiband antenna element including a high band antenna including high band radiating arms;
the multiband antenna element including a low band antenna including low band radiating arms;
the reflector including a main reflector panel, a front reflector wing forward of the main reflector panel, a rear reflector wing rearward of the main reflector panel, main sidewalls on opposite sides of the main reflector panel, front sidewalls on opposite sides of the front reflector wing, rear sidewalls on opposite sides of the rear reflector wing, a forward inner wall at the interface of the main reflector panel and the front reflector wing, and a rearward inner wall at the interface of the main reflector panel and the rear reflector wing.

2. The antenna of claim 1, wherein the front reflector wing is angled non-coplanar with the main reflector panel, the rear reflector wing being angled non-coplanar with the main reflector panel.

3. The antenna of claim 1, wherein the front reflector wing is connected to the main reflector panel at a bend, the front reflector wing being bent upward at an oblique angle relative to the main reflector panel, the rear reflector wing being connected to the main reflector panel at a bend, the rear reflector wing being bent upward at an oblique angle relative to the main reflector panel.

4. The antenna of claim 1, wherein the main sidewalls have different heights compared to the front sidewalls and the rear sidewalls.

5. The antenna of claim 1, wherein the forward inner wall and the rearward inner wall have different heights.

6. The antenna of claim 1, wherein the front reflector wing includes a forward recess aligned with the forward inner wall, the rear reflector wing including a rearward recess aligned with the rearward inner wall.

7. The antenna of claim 1, wherein the forward inner wall is parallel to the rearward inner wall, the main sidewalls being oriented perpendicular to the forward and rearward inner walls.

8. The antenna of claim 1, further comprising a secondary reflector spaced from the multiband antenna element, the secondary reflector including a central panel aligned with the high band radiating arms and the low band radiating arms.

9. The antenna of claim 8, wherein the reflector is positioned between the secondary reflector and the multiband antenna element.

10. The antenna of claim 8, wherein the secondary reflector includes a main panel and a wing panel extending from the main panel at an oblique angle.

11. The antenna of claim 8, wherein the secondary reflector is coupled to an interior surface of the bottom of the radome, the reflector being suspended in the chamber between the top and the bottom of the radome, the multiband antenna element located proximate to the top of the radome.

12. The antenna of claim 1, wherein the high band radiating arms are aligned with the main reflector panel, the low band radiating arms being aligned with the main reflector panel, the front reflector wing, and the rear reflector wing.

13. The antenna of claim 1, wherein the high band antenna is a dipole antenna, the low band antenna being a dipole antenna.

14. The antenna of claim 1, wherein the antenna assembly includes an antenna printed circuit board, the high band radiating arms formed on one or more layers of the antenna printed circuit board, the low band radiating arms formed on one or more layers of the antenna printed circuit board.

15. The antenna of claim 1, wherein the antenna assembly includes a balun coupling radiating element.

16. The antenna of claim 1, wherein the antenna assembly includes lump components.

17. The antenna of claim 1, further comprising an antenna feed including an RF connector and a coaxial cable coupled to a feed of the antenna assembly.

18. The antenna of claim 17, wherein the reflector includes a slot receiving the coaxial cable allowing the coaxial cable to pass through the reflector.

19. The antenna of claim 1, wherein the antenna assembly has a wide azimuth beamwidth wider than 90° and an elevation beamwidth wider than 60°.

20. The antenna of claim 1, wherein the high band antenna is operable at a frequency range of between 5.15 and 7.125 GHz and the low band antenna is operable at a frequency range of between 2.4 and 2.5 GHz.

21. The antenna of claim 1, wherein the reflector has a variable spacing to the multiband antenna element from front-to-rear.

22. The antenna of claim 21, wherein the front reflector wing and the rear reflector wing are closer to the multiband antenna element and the main reflector panel.

23. An antenna assembly comprising:
a multiband antenna element including a high band antenna including high band radiating arms and a low band antenna including low band radiating arms; and
a reflector spaced from the multiband antenna element and facing the antenna element, the reflector including a main reflector panel, a front reflector wing forward of the main reflector panel, a rear reflector wing rearward of the main reflector panel, main sidewalls on opposite sides of the main reflector panel, front sidewalls on opposite sides of the front reflector wing, rear sidewalls on opposite sides of the rear reflector wing, a forward inner wall at the interface of the main reflector panel and the front reflector wing, and a rearward inner wall at the interface of the main reflector panel and the rear reflector wing.

24. An antenna assembly comprising:
a multiband antenna element including a high band antenna including high band radiating arms and a low band antenna including low band radiating arms;
a reflector spaced from the multiband antenna element and facing the antenna element, the reflector including a main reflector panel, a front reflector wing forward of the main reflector panel, a rear reflector wing rearward of the main reflector panel, main sidewalls on opposite sides of the main reflector panel, front sidewalls on opposite sides of the front reflector wing, rear sidewalls on opposite sides of the rear reflector wing, a forward inner wall at the interface of the main reflector panel and the front reflector wing, and a rearward inner wall at the interface of the main reflector panel and the rear reflector wing; and
a secondary reflector spaced from the multiband antenna element, the secondary reflector including a central panel aligned with the high band radiating arms and the low band radiating arms.
